(19) United States
(12) Patent Application Publication
(10) Pub. No.: US 2006/0159588 A1
(43) Pub. Date: Jul. 20, 2006

(54) Chemical analysis device and chemical analysis cartridge

(76) Inventors: Noriyo Nishijima, Abiko (JP); Yoshihiro Nagaoka, Ishioka (JP); Toshiaki Yokobayashi, Hitachinaka (JP); Michihiro Saito, Kashiwa (JP); Nobuyuki Maki, Tsuchiura (JP); Satoshi Takahashi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/319,159

(22) Filed: Dec. 28, 2005

(30) Foreign Application Priority Data
Jan. 18, 2005 (JP) 2005-010327

(51) Int. Cl. G01N 9/30

(52) U.S. Cl. 422/72

(57) ABSTRACT

A chemical analysis device has a motor, a holder disk to be rotated by the motor, a plurality of inspection cartridges, a penetrator for penetrating the inspection cartridges, a heater and a detector. The inspection cartridge has a substrate including containers formed as recesses and a flow path, and a cover is mounted on the substrate to cover the containers and flow path. By a centrifugal force generated by a rotation of the holder disk, a liquid is moved through the flow path from the container at a radially inner side with respect to a rotational axis to the container at a radially outer side with respect to the rotational axis.

### BACKGROUND OF THE INVENTION

The present invention relates to a chemical analysis device for moving, mixing or the like of a solution with using a centrifugal force, particularly to a chemical analysis device in which a detachable cartridge is, used.

JP-A-2003-502656 discloses a device for extracting DNA from a specimen including DNA in this device, the specimen including DNA passes a glass filter so that DNA is collected. A cleaning liquid and eluate liquid pass through the glass filter holding DNA to collect only DNA. The glass filter is arranged on a rotatable constitute, and reagents such as the cleaning liquid, eluate liquid and so forth are stored in respective reagent reservoirs in the constitute. Each of the reagents is driven by the centrifugal force generated by a rotation of the constitute, and the reagents pass through the glass filter when a valve on a fine flow path between each of the reagent reservoirs and the glass filter is opened.

JP-A-2001-527220 discloses a chemical analysis device for extracting from a specimen including a plurality of chemical substances a specified chemical substance such as nucleic acid or the like to be analyzed. In a combined type cartridge, the reagents such as the solution, cleaning liquid, eluate liquid and so forth and a collector member for collecting the nucleic acid are arranged. The specimen including the nucleic acid is introduced into the cartridge so that the specimen and the eluate liquid are mixed with each other and pass though the collector member. Further, the cleaning liquid and the eluate liquid are made flow through the collecting member. The eluate liquid after passing through the collector member contacts PCR reagent, and to be transferred to a reaction chamber.

### BRIEF SUMMARY OF THE INVENTION

In the structure disclosed by JP-A-2003-502656 (WO 00/78455), the liquid such as the reagents, DNA mixture and so forth are driven by numerous valves. For the valves, wax or the like soluble by heating is used. A method using the wax closes the flow path physically to securely control the liquid flow, but needs to have respective resistor elements for the valves and heating means therefore, so that the rotatable constitute (disk) needs to be complicated, and the whole of the device is complicated for performing the sequence.

Further, the filter for collecting DNA from the DNA mixture liquid is arranged on the fine constitute, the flexible filter as well as a frit member supporting it are inserted in a groove (slot) arranged in the flow path of the rotatable constitute and are cut to have an upper surface of the same height of the disk, and a seal member is adhered to an upper surface of the disk.

For enabling the DNA mixture liquid to securely flow in the filter, the filter needs to be arranged on the flow path without a leakage. That is, if a gap exists between the filter and the flow path, the DNA mixture liquid flows through the gap to be prevented from being collected by the filter, so that a collecting efficiency for DNA is decreased. In the above filter filling method, a fine gap is easily formed between the filter and seal member, particularly in a case where the filter is flexible, it is difficult for the disk to be produced while mounting the filter without the leakage, even if the frit member is used as the supporter. Further, it is similar to a case where the gap is formed between a bottom surface of the slot and the filter.

Further, in a combined type fluidal operating cartridge disclosed by JP-A-2003-502656 (WO 00/78455), when each of the reagents is transferred by a pump, the reagent passes through the collector member by opening the valve arranged on the fine flow path between the each of the reagent chambers and the collector member. In this structure, the valves need to be arranged numerously on the cartridge to complicate the cartridge.

Therefore, an object of the present invention is to provide a cartridge of simple structure, and a chemical analysis device using it.

A chemical analysis device has a motor, a holder disk to be rotationally driven by the motor, a plurality of inspection cartridges arranged on the holder disk, a penetrator for forming a hole in the inspection cartridge, a heater and a detector. The inspection cartridge has a substrate having a container formed as a recess and a flow path, and a cover is attached to the substrate to cover the container and flow path. A solution is transferred by a centrifugal force generated by a rotation of the holder disk from the container at a radial inside with respect to a rotational axis to the container at a radial outside with respect to the rotational axis.

The flow path for transferring the solution from the container at the radial inside to the container at the radial outside extends from a radially outer side of the container at the radial inside, is bent to extend radially inward, is bent to extend radially outward, and extends to a radially inner side of the container at the radial outside. The inspection cartridge has an air flow path and a filter so that the container is connected to the atmosphere through the air flow path and the filter when the hole is formed through the cover covering the filter.

According to the invention, the cartridge of simple structure and the chemical analysis device in which it is used can be provided.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is an oblique projection view showing an outer appearance of a chemical analysis device of the invention.

FIG. 2 is an oblique projection view showing an outer appearance of an inspection cartridge of the invention.

FIG. 3 is an explanation view for explaining an operating sequence for extracting a virus nucleic acid from whole blood with using the chemical analysis device of the invention.

FIG. 4 is an explanation view for explaining in detail the operating sequence for extracting the virus nucleic acid from whole blood with using the chemical analysis device of the invention.

FIG. 5 is an explanation view for an operation of the inspection cartridge of the invention.

FIG. 6 is a view showing in detail a part of the inspection cartridge of the invention including a specimen container.

FIG. 7 is an explanation view for an operation of the inspection cartridge of the invention.

FIG. 8 is an explanation view for an operation of the inspection cartridge of the invention.

FIG. 9 is an explanation view for an operation of the inspection cartridge of the invention.

FIG. 10 is a view showing in detail a part of the inspection cartridge of the invention including the specimen container, a serum unit quantity container, and a hemocyte storage container.

FIG. 11 is an explanation view for an operation of the inspection cartridge of the invention.

FIG. 12 is an explanation view for an operation of the inspection cartridge of the invention.

FIG. 13 is an explanation view for an operation of the inspection cartridge of the invention.

FIG. 14 is an explanation view for an operation of the inspection cartridge of the invention.

FIG. 15 is an explanation view for an operation of the inspection cartridge of the invention.

FIG. 16 is a view showing a structure of a nucleic acid collector of the inspection cartridge of the invention.

FIG. 17 is a view showing a structure of a filter folder of the nucleic acid collector of the inspection cartridge of the invention.

FIG. 18 is a view showing a structure of a filter folder of the nucleic acid collector of the inspection cartridge of the invention.

FIG. 19 is a view showing a structure of another nucleic acid collector of the inspection cartridge of the invention.

FIG. 20 is an explanation view for an operation of the inspection cartridge of the invention.

FIG. 21 is an explanation view for an operation of the inspection cartridge of the invention.

FIG. 22 is an explanation view for an operation of the inspection cartridge of the invention.

FIG. 23 is an explanation view for an operation of the inspection cartridge of the invention.

FIG. 24 is an explanation view for an operation of a second cleaning liquid container of the inspection cartridge of the invention.

FIG. 25 is an explanation view for an operation of the second cleaning liquid container of the inspection cartridge of the invention.

FIG. 26 is an explanation view for an operation of the second cleaning liquid container of the inspection cartridge of the invention.

FIG. 27 is an explanation view for an operation of the inspection cartridge of the invention.

FIG. 28 is an explanation view for an operation of an eluate liquid collecting container of the inspection cartridge of the invention.

FIG. 29 is a cross sectional view showing a structure of the eluate liquid collecting container of the inspection cartridge of the invention.

FIG. 30 is a view showing in detail a part of the inspection cartridge of the invention including a specimen container, a serum unit quantity container and a hemocyte storage container.

FIG. 31 is a view showing a structure of a nucleic acid collector of the inspection cartridge of the invention.

FIG. 32 is a view showing a structure of a filter holder of the nucleic acid collector of the inspection cartridge of the invention.

FIG. 33 is a view showing a structure of a filter holder of the nucleic acid collector of the inspection cartridge of the invention.

### DETAILED DESCRIPTION OF THE INVENTION

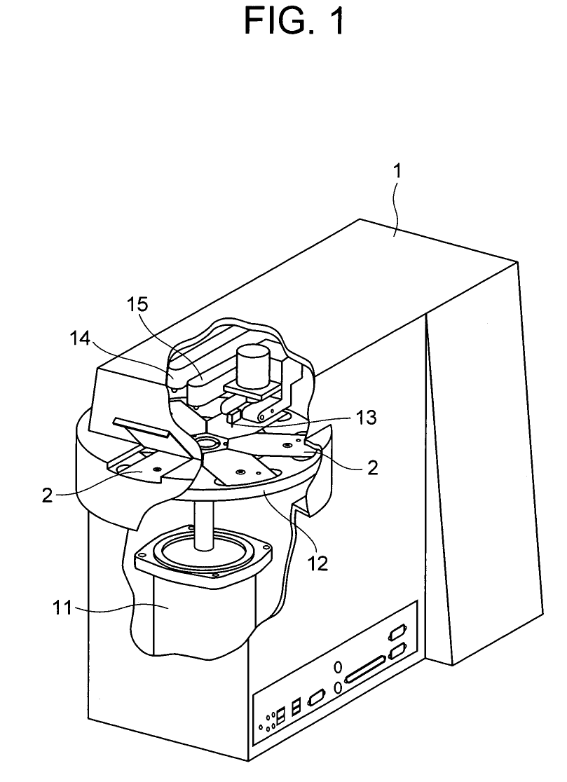

FIG. 1 is a view showing an embodiment of a chemical analysis device of the invention. The chemical analysis device 1 has a motor 11, a holder disk 12 to be rotated by the motor 11, a plurality of inspection cartridges 2 arranged on the holder disk 12, a penetrator 13 for forming a hole on the inspection cartridge 2, a heater 14 and a detector 15. An operator prepares the inspection cartridges 2 for respective inspection items, mounts them on the holder disk 12, and starts up the chemical analysis device 1.

Although the heater 14 and detector 15 are arranged at respective separated positions in the chemical analysis device of the embodiment, however, they may be combined with each other so that the heating and detecting are performed in a common position, for example. Further, although the heater and detector are arranged on an upper surface of the holder disk 12, at least one of them may be arranged on a lower surface of the holder disk 12.

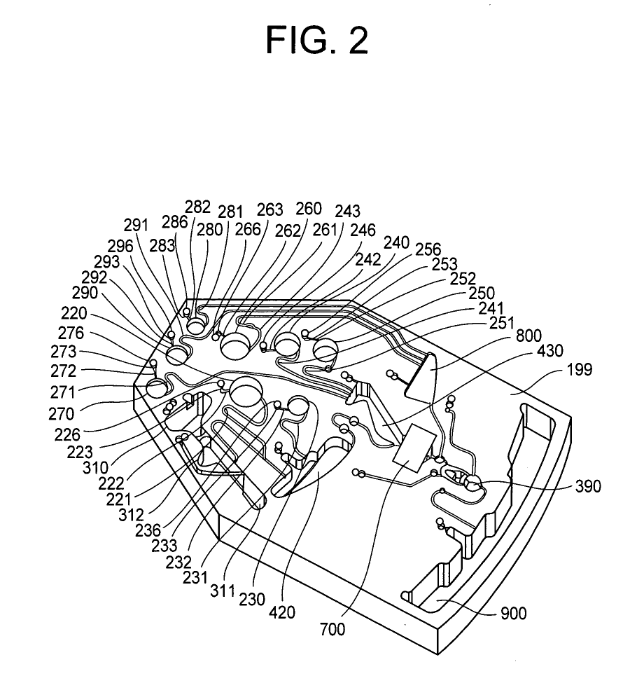

FIG. 2 is an oblique projection view showing the inspection cartridge 2. The inspection cartridge 2 has a substantially hexagonal thin substrate. A shorter side of the hexagon is arranged at a radially inner side with respect to a rotational axis of the holder disk, and a longer side of the hexagon is arranged at a radially outer side. Therefore, hereafter, the shorter side of the hexagon is called as the radially inner side, and the longer side of the hexagon is called as the radially outer side.

The inspection cartridge 2 has a solvent liquid container 220, an additional liquid container 230, cleaning liquid containers 240, 250 and 260, an eluate liquid container 270, and amplifying liquid containers 280 and 290. Reagents of respective predetermined quantities are contained in respective these reagent containers.

At radially outer sides of these reagent containers 220, 230, 240, 250, 260, 270, 280 and 290, respective outlet flow paths 221, 231, 241, 251, 261, 271, 281 and 291 are formed. The outlet flow paths have respective bent portions extending from radially outer ends of the reagent containers, bent toward the radially inner side and subsequently bent toward the radially outer side.

At radially inner sides of these reagent containers 220, 230, 240, 250, 260, 270, 280 and 290, respective air flow paths 222, 232, 242, 252, 262, 272, 282 and 292 are formed extending to enlarged flow path portions 223, 233, 243, 253, 263, 273, 283 and 293. The enlarged flow path portions extend to air filters 226, 236, 246, 256, 266, 276, 286 and 296.

The inspection cartridge 2 has further, a specimen container 310, a hemocyte storage container 311, a serum unit quantity container 312, an eluate liquid collecting container 390, a serum reaction container 420, a container at an upstream side of a nucleic acid collector, the nucleic acid collector 700, a buffer container 800 and a waste liquid container 900.

At radially inner sides of these containers 310, 311, 312, 390, 420, 430, 800 and 900, air paths, enlarged flow path portions and air filters as described below are formed.

These containers, outlet flow paths, air paths and enlarged flow path portions are formed as recesses on the inspection cartridge 2. A depth of each of the outlet flow paths and air paths is smaller than a depth of the containers.

A cartridge cover 199 as a film, thin plate or the like is adhered or bonded to an upper surface of the inspection cartridge 2 to cover the upper surface of the inspection cartridge. Therefore, the containers, outlet flow paths, air paths and enlarged flow path portions form a closed space.

In the embodiment, the solution is moved by a centrifugal force between the containers connected to each other through the flow path. At first, the cartridge cover 199 covering the air filter connected to the containers is penetrated to connect the containers to the atmosphere. Next, the holder disk is rotated to move with the centrifugal force the specimen or solution from the container of the radially inner side to the container of the radially outer side. By repeating this operation, a predetermined treatment is performed.

The specimen containers 220, 230, 240, 250, 260, 270, 280 and 290, outlet flow paths 221, 231, 241, 251, 261, 271, 281 and 291 and air flow paths 222, 232, 242, 252, 262, 272, 282 and 292 are hermetically sealed by the cartridge cover 199, and are enabled to take in the air only by penetrating the cartridge cover 199. On the other hand, in the specimen containers, outlet flow paths and air flow paths, an air of extremely small amount exists when the cartridge cover is mounted. When each of the reagents is moved to the radially outer side in the reagent container by the centrifugal force to be pressed into the outlet flow path, the air of extremely small amount contained in the reagent container expands and generates a negative pressure in the reagent container. This negative pressure and the centrifugal force balance with each other to prevent the reagent from flowing out of the reagent container.

The pressure in the reagent container further decreases in accordance with a further increase of the centrifugal force caused by an increase of rotational speed to not more than a saturated vapor pressure of the reagent so that gaseous bubble is generated. Thereby, the negative pressure decreases to be prevented from balancing with the centrifugal force. However, in the embodiment, since the outlet paths 221, 231, 241, 251, 261, 271, 281 and 291 have the bent portions returning to the radially inside, the negative pressure in the reagent container is restrained by decreasing in accordance with the increase of the centrifugal force, so that the reagent is prevented from flowing out from the outlet flow path.

Incidentally, as shown in FIG. 1, when the detector 15 is arranged on an upper side of the holder disk 12 in the chemical analysis device 1, a material of the cartridge cover 199 needs to prevent from deteriorating the detection. When the detector 15 is arranged on a lower side of the holder disk 12, the material, shape and thickness of a bottom surface of the inspection cartridge needs to prevent from deteriorating the detection.

Hereafter, a case where an extracting treatment of virus nucleic acid from a whole blood as the specimen with using the inspection cartridge 2 is explained.

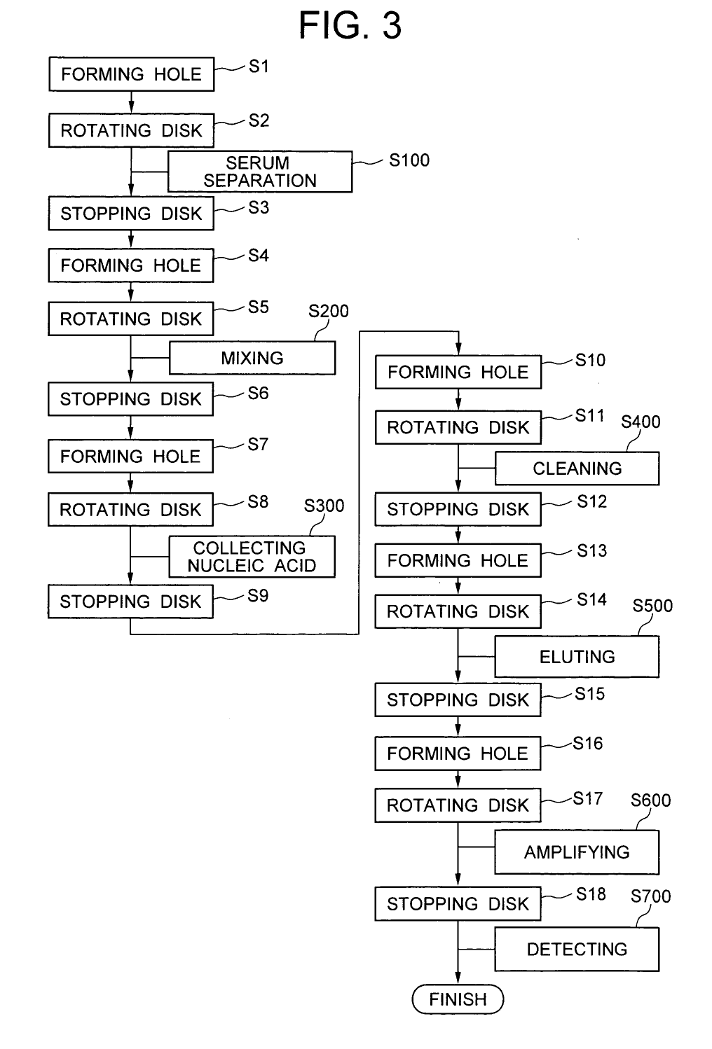

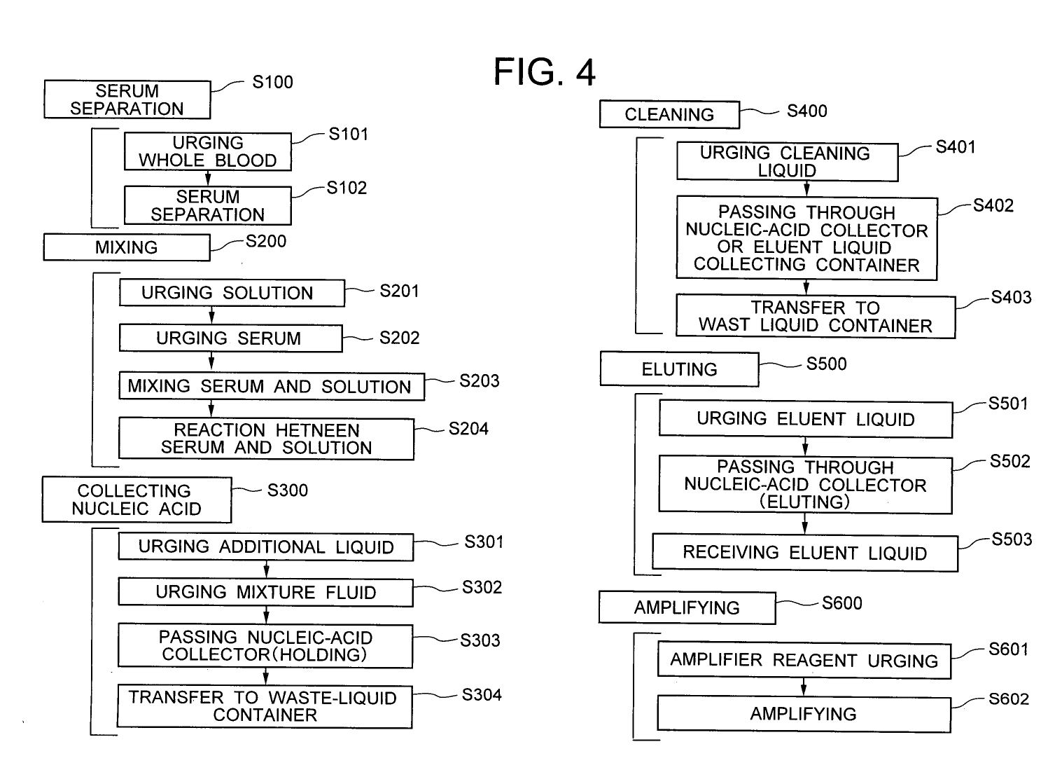

FIG. 3 shows briefly an operation of the chemical analysis device. FIG. 4 shows in detail each operation. At step S1, the cartridge cover 199 is penetrated to connect the specimen container 310 and hemocyte storage container 311 to the atmosphere. At step S2, the holder disk 12 is rotated. Thereby, at step S100, the serum of the whole blood is separated from the hemocyte. The separation of the serum at the step S100 includes two steps as shown in FIG. 4. By urging the whole blood to flow in the step S101, the whole blood I the specimen container 310 moves to the serum unit quantity container 312 and hemocyte storage container 311. In the separation of the serum at step S102, the hemocyte moves from the serum unit quantity container 312 to the storage container 311. At step S3, the rotation of holder disk is stopped.

At step S7, the cartridge cover 199 is penetrated to connect the additional liquid container 230, eluate liquid collecting container 390 and waste liquid container 900 to the atmosphere. At step S8, the holder disk 12 is rotated. Thereby, as step S300, the nucleic acid is collected. The nucleic acid collection at the step S300 includes four steps as shown in FIG. 4. At the movement of the additional liquid at step S301, the additional liquid moves from the additional liquid container 230 to the serum reaction container 420. At a movement of mixture at step S302, the mixture in the serum reaction container 420 is urged by the additional liquid to move to a nucleic acid collector 700. At a transfer through the nucleic acid collector at step S303, the mixture passes through the nucleic acid collector. At step S304, the mixture from the nucleic acid collector passes through the eluate liquid collecting container 390 to the waste liquid container 900. At step S9, the rotation of the holder disk 12 is stopped.

Next, a cleaning process is explained. The cleaning process includes first, second and third cleaning steps. At each of these cleaning steps, steps S10-S12 and step S400 are repeated. At first, the first cleaning step is explained. At step S10, the cartridge cover 199 is penetrated to connect the first cleaning liquid container 240 and the container 430 at the upstream side of the nucleic acid collector to the atmosphere. At step S11, the holder disk 12 is rotated. Thereby, the cleaning is performed at the step S400. The cleaning at step S400 includes three steps as shown in FIG. 4. At a movement of the cleaning liquid at step S401, the cleaning liquid moves from the first cleaning liquid container 240 through the container 430 at the upstream side of the nucleic acid collector to the nucleic acid collector 700. At step S402, the cleaning liquid in the first cleaning liquid container 240 cleans the container 430 at the upstream side of the nucleic acid collector and the nucleic acid collector 700. At step S403, the cleaning liquid moves from the nucleic acid collector 700 through the eluate collecting container 390 to the waste liquid container 900. At step S12, the rotation of the holder disk 12 is stopped.

The second cleaning step is explained. At step S10, the cartridge cover 199 is penetrated to connect the second cleaning liquid container 250 to the atmosphere. At step S11, the holder disk 12 is rotated. Thereby, at step S400, the cleaning is performed. The following treatment is performed similarly to the fist cleaning step. At step S12, the rotation of the holder disk 12 is stopped.

Next, the third cleaning step is explained. At step S10, the cartridge cover 199 is penetrated to connect the third cleaning liquid container 260 and buffer container 800 to the atmosphere. At step S11, the holder disk 12 is rotated. Thereby, at step S400, the cleaning is performed. At the movement of the cleaning liquid in step S401, the cleaning liquid moves from the third cleaning liquid container 260 through the buffer container 260 to the nucleic acid collector 700. At step S402, the cleaning liquid in the third cleaning liquid container 260 cleans the nucleic acid collector 700. At step S403, the cleaning liquid moves from the nucleic acid collector 700 through the eluate liquid collecting container 390 to the waste liquid container 900. At step S12, the rotation of the holder disk 12 is stopped.

At step S13, the cartridge cover 199 is penetrated to connect the eluate liquid container 270 to the atmosphere. At step S14, the holder disk 12 is rotated. Thereby, the elution is performed at step S500. The elution at step S500 includes three steps as shown in FIG. 4. At the movement of the eluate liquid at step S501, the eluate liquid moves from the eluate liquid container 270 through the container 430 at the upstream side of the nucleic acid collector to the nucleic acid collector 700. At step S502, the eluate liquid passes through the nucleic acid collector 700 to elute the nucleic acid. At step S503, the eluate liquid eluting the nucleic acid is received by the eluate liquid collecting container 390. At step S15, the rotation of the holder disk 12 is stopped.

At step S16, the cartridge cover 199 is penetrated to connect sequentially the first amplifying liquid container 290 and second amplifying liquid container 280 to the atmosphere. At step S17, the holder disk 12 is rotated. Thereby, the amplifying is performed at step S600. The amplifying at step S600 includes two steps as shown in FIG. 4. At the movement of the amplifying liquid at step S601, the amplifying liquid moves from the first amplifying liquid container 290 through the buffer container 800 to the eluate liquid collecting container 390. The amplifying liquid moves from the second amplifying liquid container 280 through the buffer container 800 to the eluate liquid collecting container 390. At step S602, the nucleic acid in the eluate liquid collecting container 390 is amplified by the amplifying liquid. The liquid collecting container 390 is heated at this time. At step S18, the rotation of the holder disk 12 is stopped.

The detection is performed at step S19. The nucleic acid in the eluate liquid collecting container 390 is detected by the detector. Hereafter, the operation of the chemical analysis device is explained in detail.

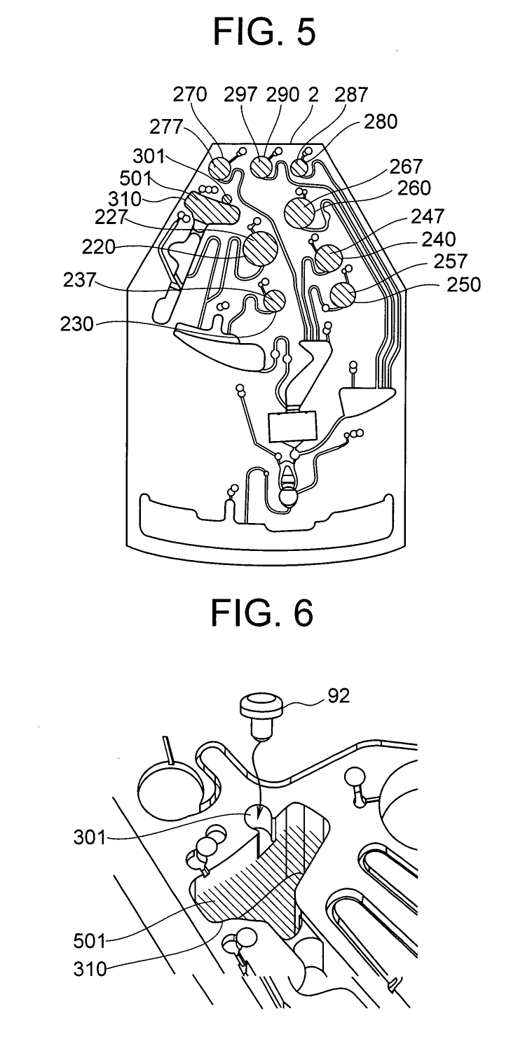

At first, a treatment of serum separation at step 100 is explained. As shown in FIG. 5, the solvent liquid 227, additional liquid 237, first cleaning liquid 247, second cleaning liquid 257, third cleaning liquid 267, eluate liquid 277, first amplifying liquid 297, second amplifying liquid 287 are contained respectively in the solvent liquid container 220, additional liquid container 230, cleaning liquid containers 240, 250 and 260, eluate liquid container 270 and amplifying liquid containers 280 and 290.

As shown in FIG. 6, the operator penetrates the cartridge cover 199 covering a specimen injection inlet 301 of the inspection cartridge 2 to inject through the specimen injection inlet 301 into the specimen container 310 the whole blood 501 collected with a vacuum blood collecting tube or the like. Next, a cap 92 is mounted on the specimen injection inlet 301. The specimen injection inlet is closed by the cap 92 to prevent the specimen from flowing out of the inspection cartridge 2.

The inspection cartridges 2 of necessary total number with the whole blood therein are mounted on the holder disk 12 as shown in FIG. 1 and the chemical analysis device 1 is activated to extract from the whole blood a gene of the virus to be detected.

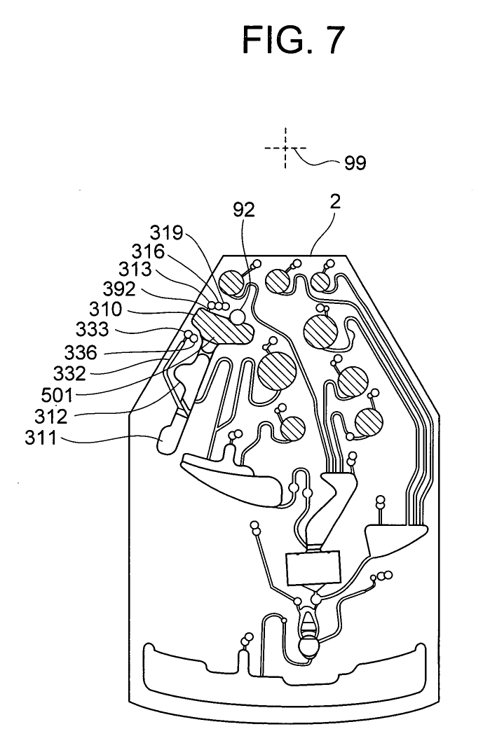

FIG. 7 shows the cartridge in which the whole blood was injected and on which the cap is mounted. The specimen container air flow path 392, enlarged portion 313 and air filter 316 are arranged at a radially inner side of the specimen container 310. The hemocyte storage container 311 and serum unit quantity container 312 are connected to each other. The hemocyte storage container air flow path 332, flow path enlarged portion 333 and air filter 336 are connected to the radially inner side of the hemocyte storage container 311. The cartridge cover is penetrated by the penetrator 13 on the air filters 316 and 336. Thereby, the specimen container 310 is connected to the atmosphere through the specimen container air flow path 392, enlarged portion 313 and air filter 316. The hemocyte storage container 311 and serum unit quantity container 312 are connected to the atmosphere through the hemocyte storage container air flow path 332, flow path enlarged portion 333 and air filter 336.

The air filter 316 us arranged between the specimen container 310 and a space 319 to be penetrated. Therefore, an upper side of the space 319 to be penetrated other than the upper side of the air filter 316 may be penetrated. In this case, the specimen container 310 is also connected to the atmosphere through the specimen container air flow path 392, enlarged portion 313 and air filter 316.

The motor 11 is activated to rotate the holder disk 12. The whole blood 501 in the specimen container 310 is moved to the radially outer side by the centrifugal force to flow to the hemocyte storage container 311 and serum unit quantity container 312.

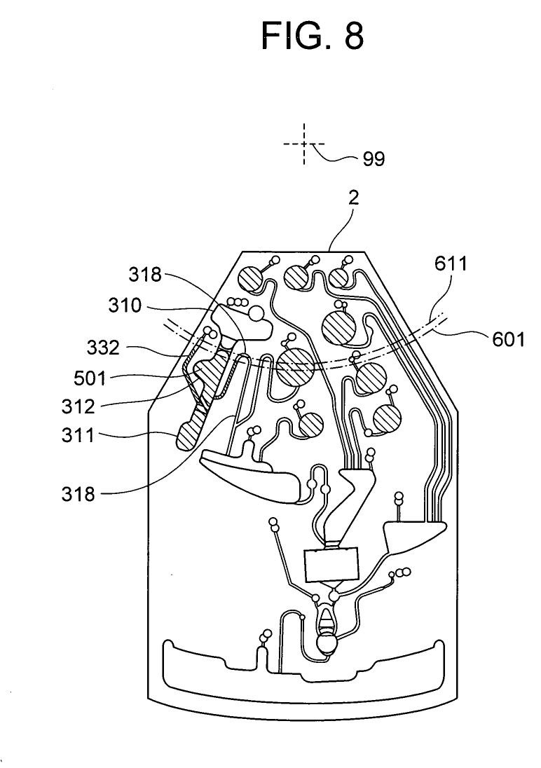

As shown in FIG. 8, an amount of the specimen of whole blood in the specimen container 310 needs to be sufficient for filling the hemocyte storage container 311 and serum unit quantity container 312. A level of the surface of the specimen of whole blood urged by the centrifugal force is on a circumference of a coaxial circle on a rotational axis 99 of the holder disk 12. At this time, a position at which the outlet path 318 of the serum unit quantity container 312 is bent is arranged as a radially inner side with respect to the level 601 of the surface of the specimen. That is, a circular arc 611 tangent with a radially outer periphery of the outlet path 318 at the bent position is arranged at a radially inner side with respect to the level 601 of the surface of the specimen. Therefore, the specimen of whole blood urged by the centrifugal force is prevented flowing from the serum unit quantity container 312 to the radially outer side over the bent position of the outlet path 318 to be held in the hemocyte storage container 311 and serum unit quantity container 312.

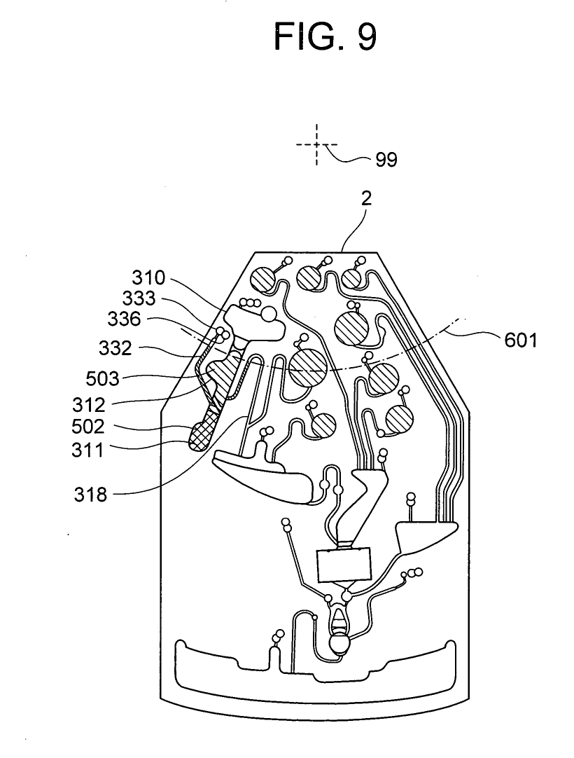

As shown in FIG. 9, when the holder disk 12 is rotated, the whole blood 501 is divided to the hemocyte and serum so that the hemocyte 502 is moved to the hemocyte storage container 311 at the radially outer side, and only the serum 503 remains in the serum unit quantity container 312.

When the whole blood 501 moves from the specimen container 310 to the hemocyte storage container 311 and the serum unit quantity container 312, the air discharged from the hemocyte storage container 311 and the serum unit quantity container 312 is discharged from the hole formed by the penetration through the hemocyte storage container air flow path 332, flow path enlarged portion 333 and air filter 336.

At first, a function of the air filter 336 is explained. It is supposed that a fine mist is generated when the specimen solution liquid is moved by the centrifugal force. The mist of the specimen is discharged together with the air through the air flow path 332 and collected by the air filter 336. Therefore, the mist of the specimen is prevented from flowing out of the cartridge.

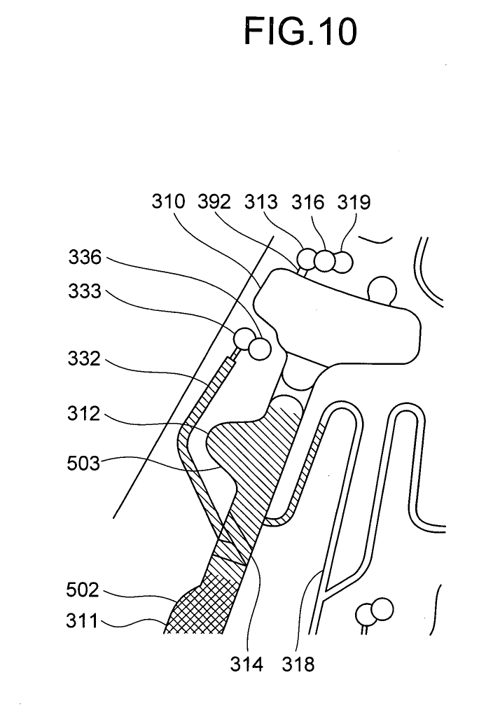

A function of the flow path enlarged portion 333 is explained. When an adhesion characteristic of the specimen is great, as shown in FIG. 10, the level of the serum moves along the air flow path 332 by capillary phenomenon in response to the stoppage of the rotation to reach a boundary (at which boundary a cross sectional area of the flow path changes abruptly between the flow path enlarged portion 333 and the flow path other than flow path enlarged portion 333) with respect to the flow path enlarged portion 333. On the other hand, at the flow path enlarged portion 333, the capillary phenomenon changes and the movement of the surface of the liquid is restrained by surface tension of the liquid. Therefore, the surface of the serum reaches the boundary with respect to the flow path enlarged portion and stops thereat.

By the flow path enlarged portion 333, the air filter is prevented from directly contacting the specimen liquid so that the air filter is prevented from being contaminated or clogged by the specimen liquid. Therefore, the air filter 336 can prevent the liquid from being flowing out of the hole formed by the penetration.

Further, with the movement of the whole blood, the air flows from the outside into the specimen container 310 through the air filter 316, enlarged portion 316 and specimen container air flow path 392. Dust or the like included by the air from the outside is collected by the air filter 316. In the inspection cartridge of the embodiment, the air flow path, enlarged flow path portion and air filter are arranged for each of the specimen container, serum reaction container 420, waste liquid container 900, buffer container 800, container 430 at the upstream side of the nucleic acid collector and so forth to obtain similar effect.

The air filter is not limited to, for example, a filter including interlacing fine fibers, but may be any type capable of collecting the mist. For example, sintered ceramics including fine holes or activated carbon for adsorbing the mist.

Further, a numerous fine dents and protrusions or fine flow paths for collecting the mist may be formed directly on the inspection cartridge 2. In this case, the filter preferably does not need to be mounted. Further, these filters may be combined with each other.

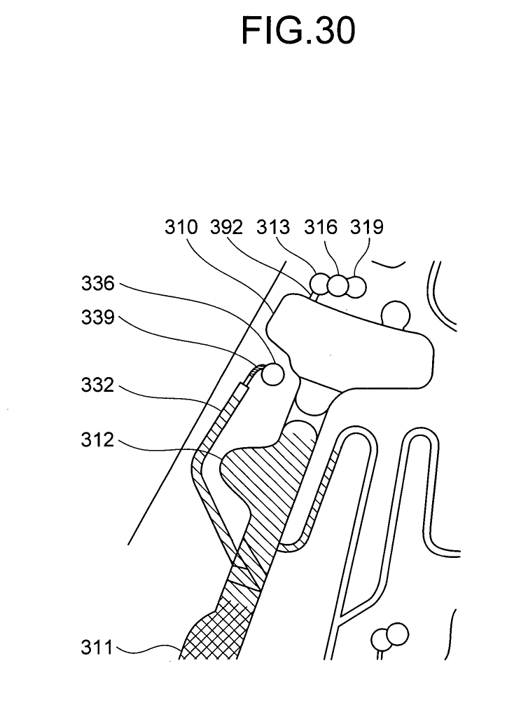

Further, the hydrophobic property may be applied as a substitute for the enlarged flow path portions 333. That is, as shown in FIG. 30, the hydrophobic property is applied to a region 339 of the flow path connecting the air flow path 332 and the air filter 336 adjacent to the air filter 336 as the substitute for the enlarged flow path portions 333. When the surface of the liquid reaches the hydrophobic property region 339, the capillary force changes in accordance with a contacting angle of the liquid to restrain the movement of the surface of the liquid. Therefore, the surface of the liquid reaches the hydrophobic property region 339 and stops thereat. The air filter 336 is prevented from contacting directly the specimen liquid to prevent the air filter from being contaminated or clogged by the specimen liquid. Therefore, the air filter can always prevent the liquid from flowing from the hole formed by the penetration.

After a serum centrifugal separation is finished in response to an elapse of a predetermined time period, the rotation of the holder disk 12 is stopped. FIG. 9 shows a situation in which the whole blood is divided to the hemocyte and serum, the hemocyte 502 is moved to the hemocyte storage container 311 at the radially outside, and the serum 503 remains in the serum unit quantity container 312 at the radially inner side. As shown in FIG. 10, an ingate 314 is arranged between the serum unit quantity container 312 and hemocyte storage container 311 to prevent the hemocyte 502 from returning from the hemocyte storage container 311 to the serum unit quantity container 312.

Next, a mixing treatment at step S200 is explained. The solvent liquid container 220 includes a solvent liquid 227 for dissolving a film of the virus or bacteria in the serum. The solvent liquid 227 dissolves protein of the film of the virus or bacteria in the serum to elute the nucleic acid, and accelerates an adsorption of the nucleic acid by the nucleic acid collector 700. As reagents, guanidine-hydrochloric acid is usable for eluting and adsorbing DNA, and guanidine-thiocyanate is usable for eluting and adsorbing RNA.

The solvent liquid container 220 has the air flow path 222, enlarged flow path portion 223 and air filter 226. The serum reaction container 420 has the serum reaction container air flow path 422, enlarged flow path portion 423 and air filter 426. The cartridge cover 199 is penetrated over the air filters 226 and 426. Thereby, the solvent liquid container 220 and serum reaction container 420 are connected to the atmosphere.

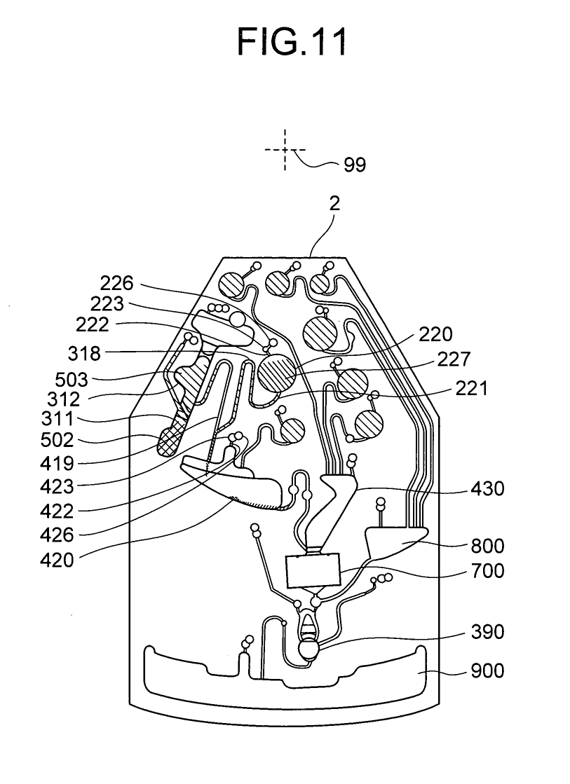

The motor 11 is activated to rotate the holder disk 12. As shown in FIG. 11, the solvent liquid 227 in the solvent liquid container 220 is moved to the radially outside by the centrifugal force, and flows into the serum reaction container 420 through the solvent liquid container outlet flow path 221 including the bent portion. The solvent liquid container outlet flow path 221 is joined at a joint portion 419 with the outlet flow path 318 extending from the serum unit quantity container 312. Therefore, when the solvent liquid 227 flows from the solvent liquid container 220 through the solvent liquid container outlet flow path 221 into the serum reaction container 420 together with the air existing in the serum unit quantity container outlet flow path 318, the pressure in the serum unit quantity container outlet flow path 318 decreases.

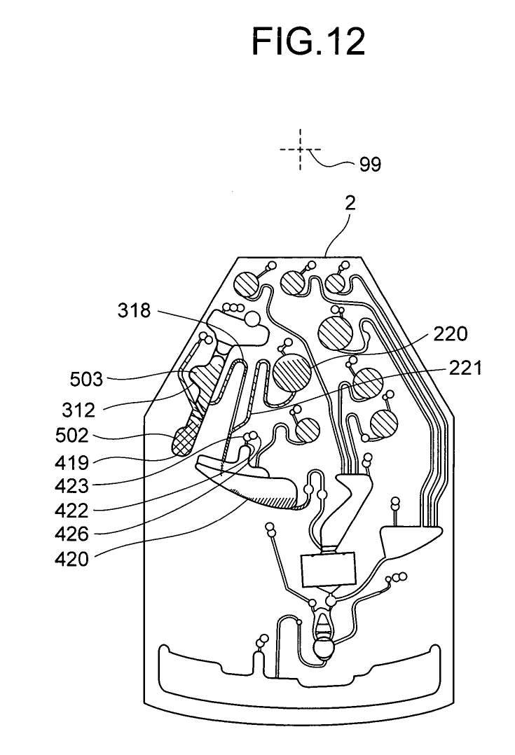

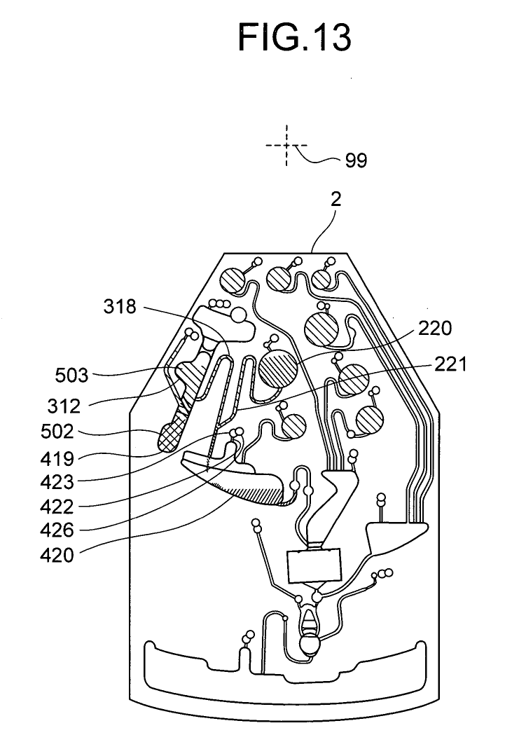

As shown in FIG. 12, the surface of the serum liquid in the serum unit quantity container outlet flow path 318 proceeds beyond the bent portion of the serum unit quantity container outlet flow path 318. When the surface of the serum liquid proceeds beyond the bent portion of the serum unit quantity container outlet flow path 318 and reaches the radially outer side with respect to the surface of the serum liquid in the serum unit quantity container 312, as shown in FIG. 13, the serum flows self-sustainingly with siphon phenomenon. The serum from the serum unit quantity container 312 joins at the joint 419 with the solvent liquid 227 from the solvent liquid container 220, and subsequently flows into the serum reaction container 420. In the serum reaction container 420, the serum and the solvent liquid 227 are mixed with each other.

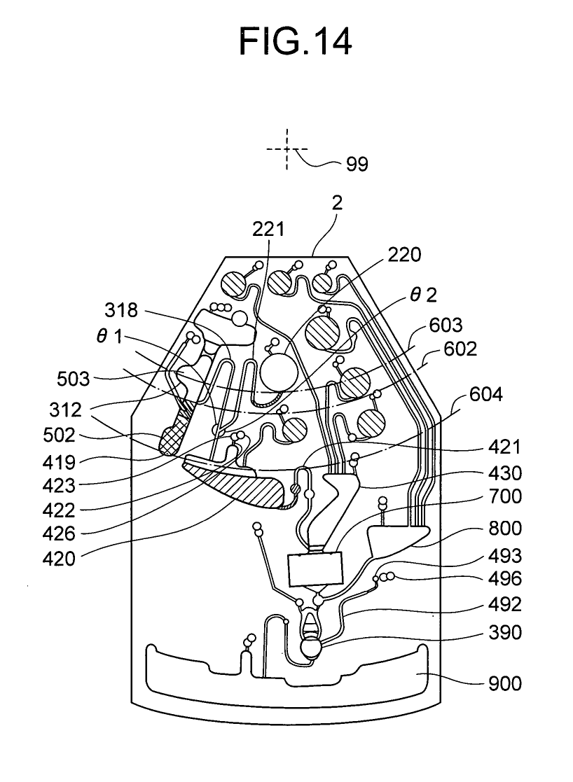

As shown in FIG. 14, by continuously rotating the holder disk 12, a major part of the solvent liquid 227 in the solvent liquid container 220 other than a extremely small remainder amount thereof moves to the serum reaction container 420. The level of the surface of the serum in the serum unit quantity container 312 becomes at a position where the serum unit quantity container outlet flow path 318 is connected to the serum unit quantity container 312, that is, the same level as the outlet 602 of the serum unit quantity container 312.

In the embodiment, at the joint 419, the solvent liquid container outlet flow path 221 extending from the solvent liquid container 220 is connected to the serum unit quantity container outlet flow path 318 extending from the serum unit quantity container 312. By the flow of the solvent liquid 227 through the solvent liquid container outlet flow path 221, the air is taken in from the serum unit quantity container outlet flow path 318 to generate the flow of the serum from the serum unit quantity container outlet flow path 318. Therefore, without complicated valve mechanism, the serum and solvent liquid 227 are mixed with each other in the serum reaction container 420.

By increasing the amount of the solvent liquid 227 flowing out of the solvent liquid container outlet flow path 221, the amount of the serum flowing out of the serum unit quantity container outlet flow path 318 is increased. The amount of the solvent liquid 227 flowing out of the solvent liquid container outlet flow path 221 needs to be sufficient for at least generating the flow of the serum from the serum unit quantity container outlet flow path 318. If the amount of the solvent liquid 227 flowing out of the solvent liquid container outlet flow path 221 is small, there is a probability of that the flowing out of the solvent liquid 227 is completed while the flow of the serum from the serum unit quantity container outlet flow path 318 cannot be generated.

It is preferable that a cross sectional area of the serum unit quantity container outlet flow path 318 is smaller than a cross sectional area of the solvent liquid container outlet flow path 221. Thereby, a volume of the air withdrawn from the serum unit quantity container outlet flow path 318 in accordance with the flowing out of the solvent liquid is made small to securely generate the flow of the serum from the serum unit quantity container outlet flow path 318.

Further, making a length from the joint 419 to the serum reaction container 420 as long as possible, the flow of the serum from the serum unit quantity container outlet flow path 318 can be generated further securely. In the change of the pressure from the joint 419 to the inlet of the serum reaction container 420, the pressure becomes the atmospheric pressure at the inlet of the serum reaction container 420, and decreases toward an upstream side thereof. The longer the distance from the joint 419 to the serum reaction container 420 is, the lower the pressure at the joint 419 is. Therefore, the flow of the serum from the serum unit quantity container outlet flow path 318 can be generated further securely.

It is preferable for the distance from the joint 419 to the inlet of the serum reaction container 420 to be made longer than a radial distance from the radially outermost position 603 of the solvent liquid container 220 to the joint 419. Thereby, the flow of the serum from the serum unit quantity container outlet flow path 318 can be generated further securely.

Further, it is preferable for a cross sectional area of the flow path from the joint 419 to the inlet of the serum reaction container 420 to be not more than a cross section of one of the solvent liquid container outlet flow path 221 and serum unit quantity container outlet flow path 318 having greater cross sectional area before being combined with each other. By setting the cross sectional areas of the flow paths before and after being combined with each other, the air is prevented from flowing in a reverse direction from the inlet of the serum reaction container 420 to generate a stable flow.

Further, as shown in FIG. 14, when an angle θ1 is formed between the flow path from the joint 419 to the inlet of the serum reaction container 420 and the serum unit quantity container outlet flow path 318 and an angle θ2 is formed between the flow path from the joint 419 to the inlet of the serum reaction container 420 and the solvent liquid container outlet flow path 221, it is preferable that θ1=180 degrees or θ1≧θ2. It is preferable for taking the air from the serum unit quantity container outlet flow path 318 to further securely generate the flow of the serum from the serum unit quantity container outlet flow path 318 that the flow of the solvent liquid for generating the flow of the serum from the serum unit quantity container outlet flow path 318 converges obliquely with the flow of the serum.

For accelerating the mixing between the solvent liquid 227 and the serum, it is preferable for a time period in which they flow simultaneously to be made longer. That is, it is preferable for a time period necessary for discharging the whole of the solvent liquid 227 and a time period necessary for discharging the whole of the serum to be made equal to each other. When a quantity of the solvent liquid 227 and a quantity of the serum are equal to each other, it is preferable for flow rates thereof to be made equal to each other. When the quantity of the solvent liquid 227 and the quantity of the serum are different from each other, the flow rate for the greater quantity is made greater or the flow rate for the smaller quantity is made smaller, so that the time periods necessary for discharging the wholes of the liquids are made equal to each other.

When the quantity of the solvent liquid 227 is greater than the quantity of the serum, as described below, the radially outermost position 603 of the solvent liquid container 220 is set at the position 602 of the outlet of the serum unit quantity container 312, or at a radially inner side with respect thereto, so that the time period in which they flow simultaneously is increased.

When they flow simultaneously, in accordance with a decrease of the centrifugal force, the flow rate of the solvent liquid 227 with its higher surface level (at the radially inner side) becomes greater so that decreasing velocities of the surface levels of them are made substantially equal to each other. Therefore, in this case, by setting the radially outermost position 603 of the solvent liquid container 220 at the position 602 of the outlet of the serum unit quantity container 312, the flowing-out of the liquids from the containers 220 and 312 can be completed simultaneously. Therefore, the time period in which the liquids flow from the containers 220 and 312 simultaneously is maximized to accelerate the mixing of the liquids.

The increase of the centrifugal force causes an increase in effect of a flow path resistance to decrease the decreasing velocity of the surface level of the solvent liquid 227 of the higher surface level (at the radially inner side). Therefore, in this case, by setting the radially outermost position 603 of the solvent liquid container 220 at the radially inner side with respect to the position 602 of the outlet of the serum unit quantity container 312, the time period in which the liquids flow from the containers 220 and 312 simultaneously is maximized to accelerate the mixing of the liquids.

On the other hand, when the quantity of the solvent liquid 227 is smaller than the quantity of the serum, a flow path width of the serum unit quantity container outlet flow path 318 is decreased, a depth of the flow path is decreased, or the length of the flow path is increased, so that the flow path resistance is increased relatively. Thereby, the flow rate of the solvent liquid of the smaller quantity is decreased to increase a time period necessary for discharging the whole of the solvent liquid 227. Therefore, the time period in which they flow simultaneously is increased to accelerate the mixing of the liquids.

Further, when the adhesion property of the serum is extremely high, there is a probability of that, in response to the stoppage of the rotation, the serum flows in the reverse direction from the serum reaction container 420 through the serum unit quantity container outlet flow path 318 by the capillary phenomenon. In this case, the solvent liquid is moved by the similar process so that they flow simultaneously in the serum reaction container. That is, in the embodiment, irrespective of the adhesion property of the liquid, the liquids flow simultaneously.

By setting appropriately a volume of the serum unit quantity container 312, a cross sectional area and length of the serum unit quantity container outlet flow path 318 and a position of the serum unit quantity container outlet flow path 318, irrespective of a difference in ratio of serum with respect to the whole blood between the specimens, an amount of the serum necessary for the analysis can be obtained. For example, a case where the volume of the serum unit quantity container 312 is 300 micro-liters and the necessary amount of the serum is 200 micro-liters is estimated. When 500 micro-liters of the whole blood is applied, a part of 200 micro-liters of the separated serum flows to the serum reaction container 420. That is, in the inspection cartridge of the embodiment, the serum of 200 micro-liters is obtainable from the whole blood of 500 micro-liters. When the ratio of the serum in the specimen is low, the volume of the hemocyte storage container 311 needs to be enlarged.

In the serum reaction container 420, the mixed serum and solvent liquid react each other. The outlet of the serum reaction container 420 is connected to the reaction liquid flow path 421 including the bent portion is connected. The liquid surface level of the serum reaction container 420 is, as shown in FIG. 14, at the radially outer side with respect to the radially innermost portion 604 of the bent portion of the reaction liquid flow path 421. Therefore, when the centrifugal force is applied, the mixture in the serum reaction container 420 cannot exceeds the bent portion of the reaction liquid flow path 421 to be held in the serum reaction container 420.

After the motor is rotated during a predetermined time period to complete the mixing process for the serum and the solvent liquid, the motor 11 is stopped to prevent the holder disk from being rotated.

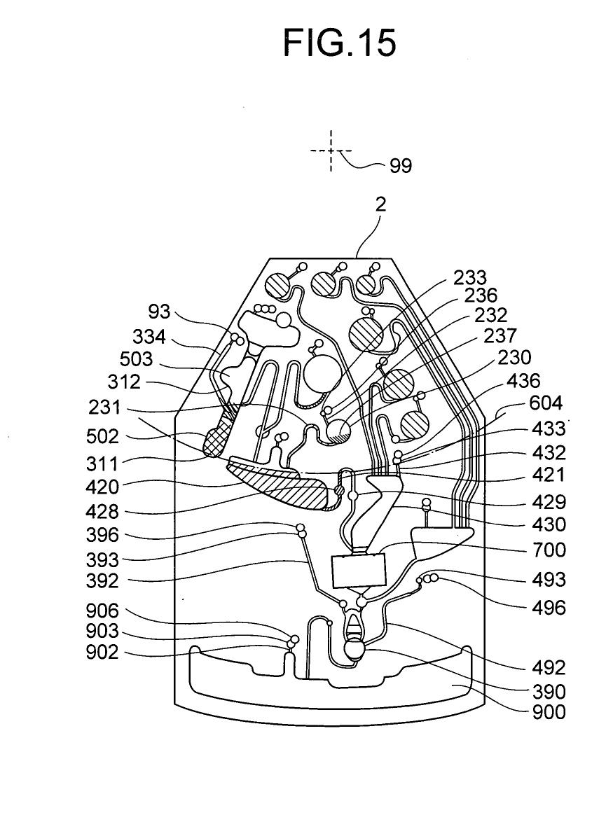

Next, the nucleic acid collecting treatment at step S300 is explained. As shown in FIG. 15, the additional liquid container 230 includes the air flow path 232, enlarged flow path portion 232 and air filter 236. The penetrator 13 forms a hole through the cartridge cover 199 on the upper side of the air filter 236. Thereby, the additional liquid container 230 is connected to the atmosphere.

The container 430 at the upstream side of the nucleic acid collector has an air flow path 432 for container at the upstream side of the nucleic acid collector, enlarged flow path portion 433 and air filter 436. The penetrator penetrates forms a hole through the cartridge cover 199 on the upper side of the air filter 436. The solvent liquid collecting container 390 includes a buffer flow path 492, enlarged flow path portion 493, air filter 496 and a space 499 for being penetrated. The penetrator 13 penetrates the cartridge cover 199 on the upper side of the space 499 for being penetrated. The waste liquid container 900 includes the waste liquid container air flow path 902, enlarged flow path portion 903 and air filter 906. The penetrator 13 penetrates the cartridge cover 199 on the upper side of the air filter 906. Thereby, the container 430 at the upstream side of the nucleic acid collector, solvent liquid container 390 and waste liquid container 900 are connected to the atmosphere.

The motor 11 is activated to rotate the holder disk 12. By the centrifugal force, the additional liquid 237 moves from the additional liquid container 230 through the additional liquid outlet flow path 231 to the serum reaction container 420. Thereby, the liquid surface level of the mixture liquid in the serum reaction container 420 moves radially inward. When the liquid surface level of the mixture liquid reaches the radially innermost position 604 of the reaction liquid flow path 421, the mixture liquid exceeds the bent portion of the reaction liquid flow path 421 to flow through the inner peripheral portion of the container 430 at the upstream side of the nucleic acid collector, to the nucleic acid collector portion 700. The additional liquid 237 may be the same as the solvent liquid 227.

Incidentally, when the adhesion property of the mixture liquid of the specimen and solvent liquid for the wall surface is great, there is a probability of that the mixture liquid flows in the reverse direction in the reaction liquid flow path 421 by the capillary phenomenon when the centrifugal force is not applied. In this case, the additional liquid is not needed.

The reaction liquid flow path 421 has two enlarged flow path portions 428 and 429. These enlarged flow path portions 428 and 429 prevents the liquid from moving through the reaction liquid flow path 421 by the capillary phenomenon when the centrifugal force is not applied. The enlarged flow path portions 428 and 429 prevent a contamination caused by flowing-out of the liquid of small amount remaining in the serum reaction container 420 and the container 430 at the upstream side of the nucleic acid collector when the below mentioned cleaning process is performed or after the cleaning process.

Similarly to the enlarged flow path portion arranged for the air filter, the enlarged flow path portion may be replaced by a region to which hydrophobic property is applied to obtain the same effect.

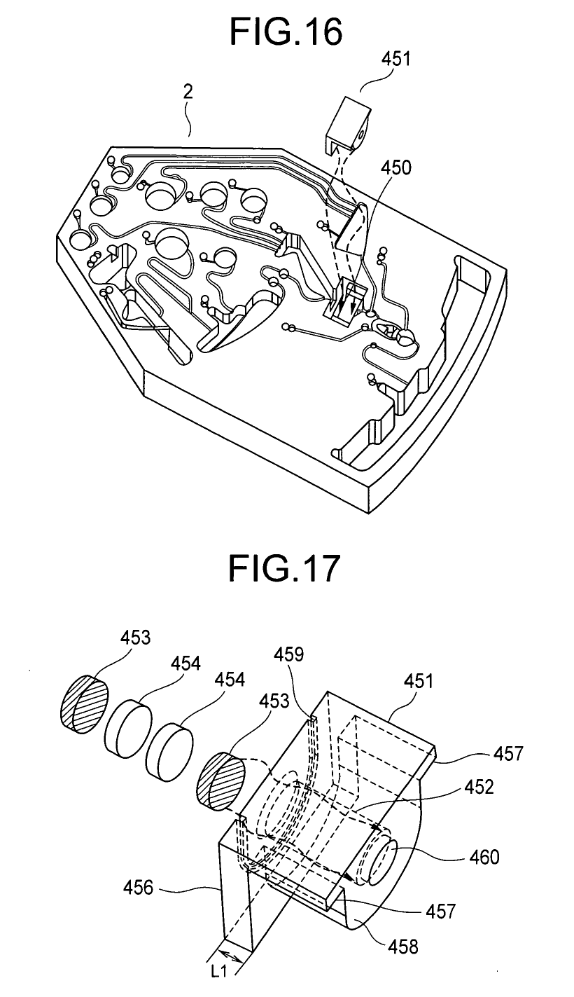

With making reference to FIGS. 16-19, a first embodiment of the nucleic acid collector portion 700 is explained. The nucleic acid collector portion 700 has a recess 450 formed on the upper surface of the inspection cartridge 2 and a filter holder 451 inserted thereto.

As shown in FIG. 17, the filter holder 451 has a vertical wall 456, upper side wall 457 and semicylindrical filter holding portion 458. The filter holding portion 458 has a hole 452 of circular cross section. A projection 460 is formed on an outlet side of the hole 452. A filter supporter 453, nucleic acid collecting filter 454 and filter supporter 453 are inserted in order into the hole 452. The filter supporter 453 and nucleic acid collecting filter 454 are positioned in the hole 452 by the projection 460. The nucleic acid collecting filter 454 is formed of quartz or glass fiber filter or the like for collecting the nucleic acid. When the nucleic acid collecting filter 454 is formed by a flexible member such as mesh or fiber, as shown in the drawing, it is preferable for the nucleic acid collecting filter 454 to be arranged between the filter supporters 453. Such structure prevents the nucleic acid collecting filter 454 from being deformed. In this case, two of the nucleic acid collecting filters 454 are inserted, however, any number of the nucleic acid collecting filters 454 sufficient for collecting the nucleic acid to be inspected may be used.

In the nucleic acid collector portion 700 of the embodiment, the liquid from the container 430 at the upstream side of the nucleic acid collector passes only through the nucleic acid collecting filter 454. That is, a seal structure is arranged between the recess 450 of the inspection cartridge 2 and the filter holder 451 to prevent the liquid flow therebetween. This seal structure is explained.

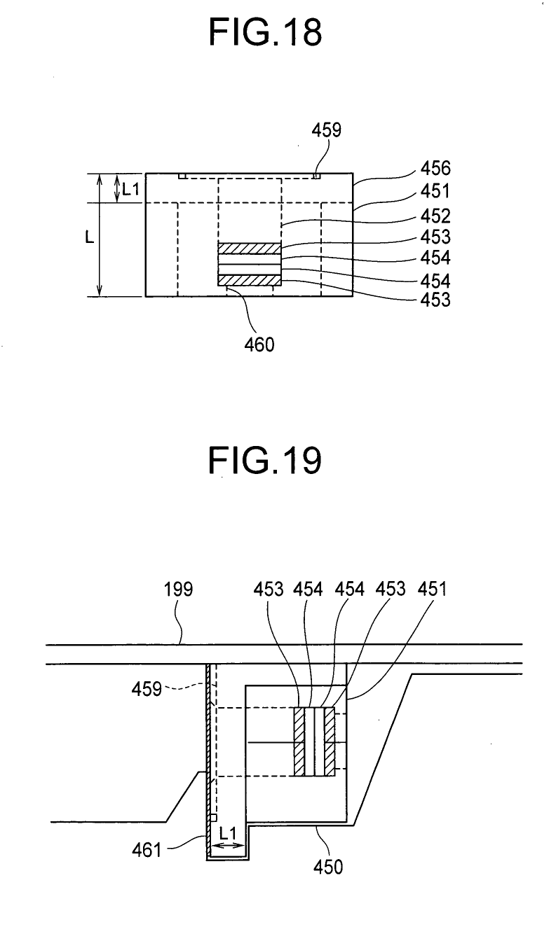

As shown in FIG. 18, a thickness of the vertical wall 456 of the filter holder 451 is shorter than the whole length of the filter holder. A groove corresponding to the vertical wall 456 is formed on an inner surface of the recess 450 of the inspection cartridge.

When assembling the nucleic acid collector portion 700 of the embodiment, an adhesive is applied to the vertical wall 456 of the filter holder 451 or the inner surface of the recess 450 of the inspection cartridge. As shown in FIG. 19, when the filter holder 451 is inserted into the recess 450 of the inspection cartridge, the vertical wall 456 engages with the groove formed in the recess of the inspection cartridge 2. They are adhered to each other, and a gap between them is filed with the adhesive. In this situation, the upper surface of the inspection cartridge 2 and the upper surface of the upper side wall 457 of the filter holder 451 form a common plane.

The vertical wall 456 of the filter holder 451 further has a groove 459 surrounding the hole 452. The groove 459 is closed by the vertical wall of the recess 450 of the inspection cartridge. The adhesive is held by this groove 459. By the adhesive held by the groove 459, the vertical wall 456 of the filter holder 451 and the recess 450 of the inspection cartridge are securely adhered to each other.

In this embodiment, since the vertical wall 456 of the filter holder 451 and the recess 450 of the inspection cartridge form the seal structure, dimensions of only the vertical wall 456 of the filter holder 451 and the groove of the recess 450 of the inspection cartridge need to be formed with high accuracy. That is, an accuracy of dimension L of the whole length of the filter holder 451 may be low. Therefore, a production control is easy.

In the nucleic acid collector portion 700 of the embodiment, the nucleic acid collecting filter 454 is mounted on the filter holder 451 to be mounted in the recess of the inspection cartridge. Therefore, the producing process for the nucleic acid collector portion 700 and assembling work for the nucleic acid collecting filter 454 become easy.

If the nucleic acid collecting filter 454 is directly mounted on the inspection cartridge, the inspection cartridge needs to have a recess corresponding to an outer shape of the nucleic acid collecting filter 454 so that it is difficult for the producing accuracy to be kept. Further, a work of arranging the two nucleic acid collecting filters 454 between the filter supporters 453 and mounting their combination in to the recess of the inspection cartridge is complicated.

In this embodiment, since the filter holder 451 is used, the recess formed in the inspection cartridge has a shape corresponding to the outer shape of the vertical wall 456 of the filter holder 451 other than the outer shape of the nucleic acid collecting filter 454. Therefore, since the vertical wall 456 of the filter holder 451 has a desired outer shape, the shape of the recess formed in the inspection cartridge may has a desired shape.

When the nucleic acid collecting filter 454 is formed of the flexible member such as fiber or mesh, it is preferable for an outer diameter of the nucleic acid collecting filter 454 to be slightly greater than an inner diameter of the hole 452 of the filter holder 451. By inserting the nucleic acid collecting filter 454 into the hole 452 of the filter holder 451, the nucleic acid collecting filter 454 is compressed radially. Thereby, the seal is kept between the nucleic acid collecting filter 454 and the hole 452 of the filter holder 451.

In this embodiment, a plurality of the filter holders including respective nucleic acid collecting filters 454 different from each other are prepared, and a desired one of them is selected in accordance with a use application of the inspection cartridge on which the filter holder is mounted. Therefore, the inspection cartridge for various use applications can be easily produced.

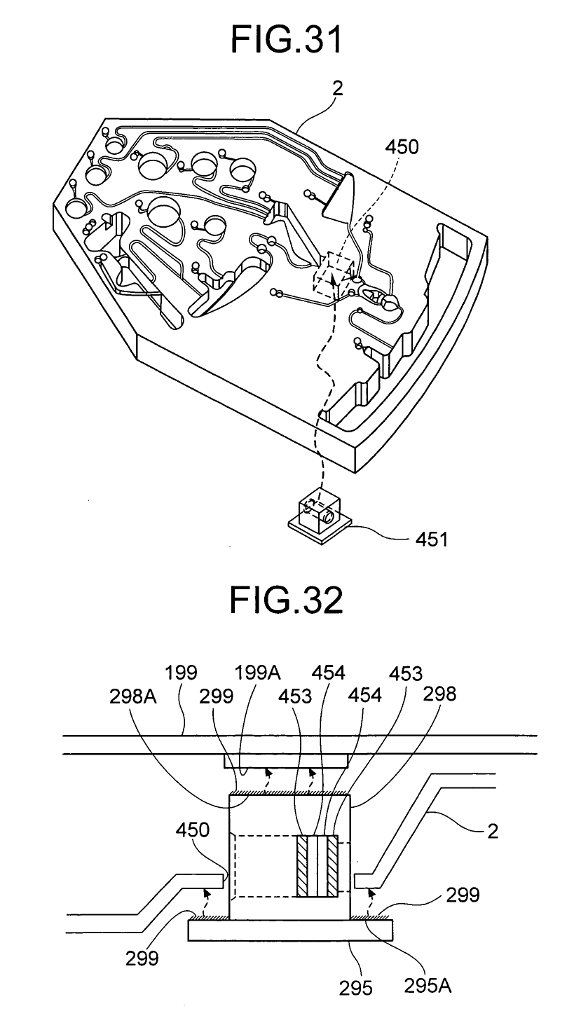

A second embodiment of the nucleic acid collector portion 700 is explained with making reference to FIGS. 31 and 32. The nucleic acid collector portion 700 of the embodiment includes a recess 450 formed on an lower surface of the inspection cartridge 2 and the filter holder 451 inserted therein. The filter holder 451 has a lower side wall 295 and the filter holding portion 298. The filter holding portion 298 includes a hole of circular cross section. A recess is formed on the outlet side of the hole. The filter supporter 453, nucleic acid collecting filter 454 and filter supporter 453 are inserted in order into the hole.

As shown in FIG. 32, the filter holder including the filter supporter 453 and nucleic acid collecting filter 454 is inserted into the recess 450 formed on the lower surface of the inspection cartridge 2. An upper surface 298A of the filter holding portion 298 is adhered by the adhesive 299 to a lower surface 199A of the upper side member of the inspection cartridge. An upper surface 295A of the lower side wall 295 is adhered by the adhesive 299 to the lower surface of the lower side portion of the inspection cartridge.

The nucleic acid collector portion 700 of the embodiment has the following effect. Since the filter holder is inserted from the lower surface of the inspection cartridge, the filter holder can be mounted after the cartridge cover 199 is mounted on the inspection cartridge. Further, although the cartridge cover needs to be adhered to both the inspection cartridge and filter holder, the cartridge cover may be adhered to only the inspection cartridge in the embodiment so that the adhesion work for the cartridge cover becomes easy. For example, when the cartridge cover is adhered by thermal welding, the filter holder and inspection cartridge need to be formed by a common material in the first embodiment to easily adhere them by thermal welding to each other simultaneously, however, a material of the filter holder may be freely selected in this embodiment.

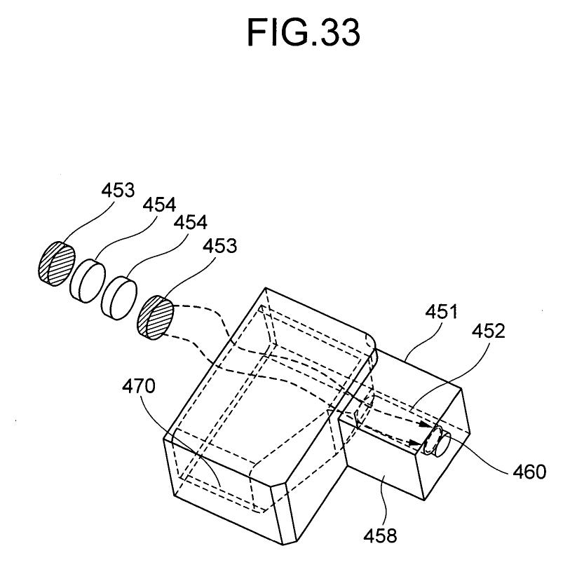

FIG. 33 shows a third embodiment of the nucleic acid collector portion 700. The nucleic acid collector portion 700 has, similarly to the first embodiment shown in FIG. 31, the recess 450 formed on the upper surface of the inspection cartridge 2 and the filter holder 451 inserted therein.

The filter holder 451 has a liquid receiving space 470 and the filter holding portion 458. The filter holding portion 458 includes the hole 452 of circular cross section. The recess 460 is formed on the outlet side of the hole 452. The filter supporter 453, nucleic acid collecting filter 454 and filter supporter 453 are inserted in order into the hole 452.

The liquid receiving space 470 holds the liquid flowing into the filter holder before passing through the nucleic acid collecting filter 454. The liquid receiving space 470 acts as the container 430 at the upstream side of the nucleic acid collector. Therefore, when the nucleic acid collector portion 700 of this embodiment is used, the container 430 at the upstream side of the nucleic acid collector does not need to be used. A volume of the liquid receiving space is greater than the maximum amount of the liquid flowing into the nucleic acid collecting filter. The nucleic acid collector portion 700 of this embodiment has the following effect. By the liquid receiving space, a leakage of the liquid through the gap between the filter holder and inspection cartridge is prevented. That is, when the centrifugal force is applied, the liquid held in the liquid receiving space cannot flow out of the filter holder so that it necessarily passes through the nucleic acid collecting filter.

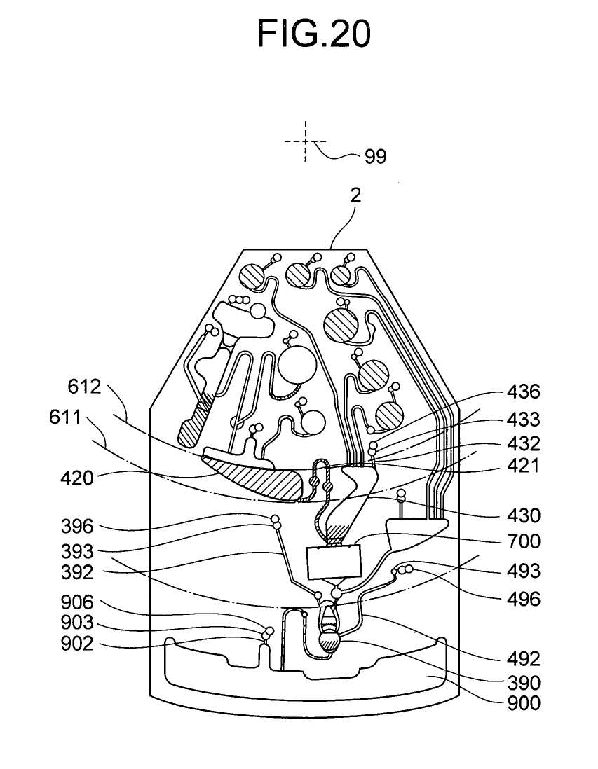

The function of the container 430 at the upstream side of the nucleic acid collector is explained with making reference to FIG. 20. The mixture liquid in the serum reaction container 420 flows into the nucleic acid collector portion 700 through the inner peripheral portion of the container 430 at the upstream side of the nucleic acid collector. When the mixture liquid passes through the nucleic acid collector portion 700, the nucleic acid is adsorbed by the nucleic acid collecting filter of the nucleic acid collector portion 700, and the liquid flows into the eluate liquid collecting container 390.

For securely collecting the nucleic acid at the nucleic acid collecting filter, a filter of micro openings needs to be used. The filter of micro openings has a great resistance against a liquid pass, an amount of the eluate liquid passing through the nucleic acid collecting filter is smaller than an amount of the eluate liquid flowing into the nucleic acid collector portion 700 so that the eluate liquid is stored at the upstream side of the nucleic acid collecting filter. When the container 430 is not arranged at the upstream side of the nucleic acid collector, the eluate liquid stored at the upstream side of the nucleic acid collecting filter returns to and contaminate the outlet flow path of the cleaning liquid. Therefore, it is preferable for the container 430 to be arranged at the upstream side of the nucleic acid collector.

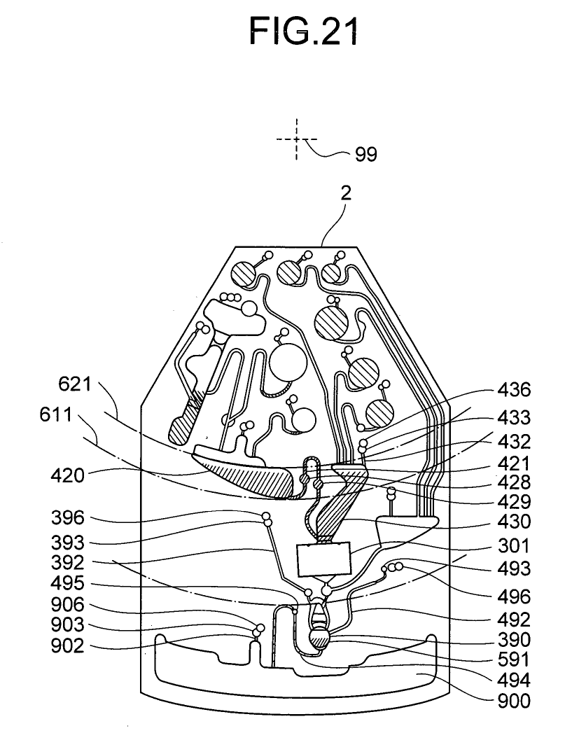

The volume of the container 430 at the upstream side of the nucleic acid collector may be equal to the volume of the serum reaction container 420. However, by arranging at a radially inner side with respect to the radially outermost position 611 of the serum reaction container 420 the radially innermost position 612 of the container 430 at the upstream side of the nucleic acid collector as shown in FIG. 21, the volume of the container 430 at the upstream side of the nucleic acid collector may be decreased. When the mixture liquid in the serum reaction container 420 is stored in the container 430 at the upstream side of the nucleic acid collector, the liquid surface level in the container 430 at the upstream side of the nucleic acid collector ascends to become the same as the liquid surface level in the serum reaction container 420. When the liquid surface level in the container 430 at the upstream side of the nucleic acid collector becomes equal to the liquid surface level in the serum reaction container 420, the mixture liquid is prevented from flowing from the serum reaction container 420 to the container 430 at the upstream side of the nucleic acid collector. That is, since the mixture liquid stored at the upstream side of the nucleic acid collecting filter is held by both of the serum reaction container 420 and the container 430 at the upstream side of the nucleic acid collector, the volume of the container 430 at the upstream side of the nucleic acid collector may be smaller than the volume of the serum reaction container 420.

By decreasing the volume of the container 430 at the upstream side of the nucleic acid collector, the amount of the cleaning liquid for cleaning the container 430 at the upstream side of the nucleic acid collector can be decreased to decrease a capacity for the cleaning liquid.

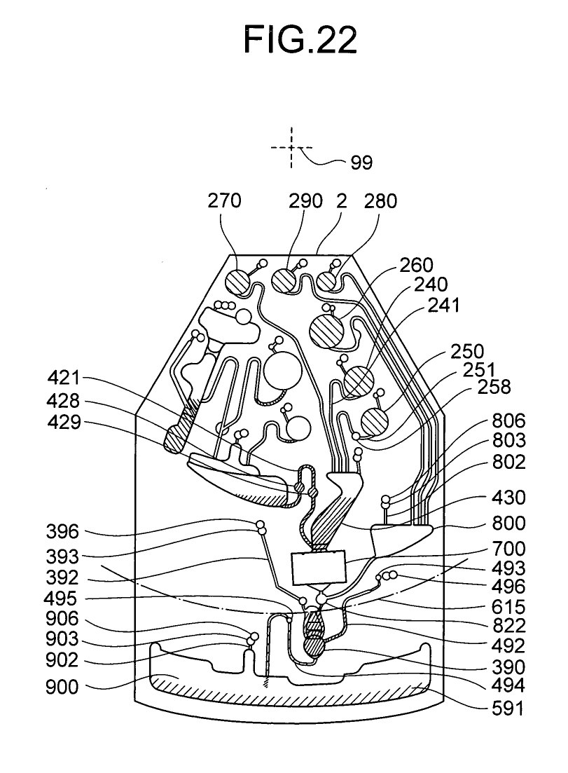

As shown in FIG. 22, the waste liquid 591 after passing through the nucleic acid collector portion 700 flows into the eluate liquid collecting container 390 through the enlarged flow path portion 822. The eluate liquid collecting container outlet flow path 494 including the bent portion is connected to the radially outer end of the eluate liquid collecting container 390. Since the volume of the eluate liquid collecting container 390 is significantly smaller than the amount of the waste liquid, the waste liquid exceeds the radially innermost position 615 of the bent portion of the eluate liquid collecting container outlet flow path 494 to flow into the waste liquid container 900. After the whole of the waste liquid moves to the waste liquid container 900, the next cleaning process is performed.

The cleaning process at step S400 is explained. The cleaning process includes first and second cleaning steps. At first, the first cleaning step is performed. The first cleaning liquid container 240 contains a first cleaning liquid for cleaning the container 430 at the upstream side of the nucleic acid collector and washing out unrequired component such as protein or the like from the nucleic acid collecting filter 254 of the nucleic acid collector 700. The first cleaning liquid may be the above mentioned solvent liquid or a liquid whose salinity is decreased in comparison with the solvent liquid. The amount of the first cleaning liquid is smaller than the volume of the container 430 at the upstream side of the nucleic acid collector. The outlet flow path 241 including the bent portion is connected to the radially outer side of the first cleaning liquid container 240. As shown in FIG. 2, the air flow path 242, enlarged flow path portion 243 and air filter 246 are connected to the radially inner side of the first cleaning liquid container 240.

The motor 11 is stopped, and the penetrator 13 penetrates the cartridge cover 199 on the upper side of the air filter 246. Thereby the first cleaning liquid container 240 is connected to the atmosphere. By rotationally activating the motor 11, with the centrifugal force, the first cleaning liquid flows from the first cleaning liquid container 240 to the nucleic acid collector 700 through the first cleaning liquid container outlet flow path 241 and the container 430 at the upstream side of the nucleic acid collector, so that the unrequited component such as protein or the like is washed out from the nucleic acid collecting filter 254. The waste liquid after cleaning flows out to the waste liquid container 900 through the enlarged flow path portion 822 and the eluate liquid collecting container 390.

Next, the second cleaning step is performed. The second cleaning liquid container 250 contains the second-cleaning liquid for washing out an unrequired component such as salt or the like from the container 430 at the upstream side of the nucleic acid collector and the nucleic acid collector 700. The second cleaning liquid may be ethanol or aqueous solution of ethanol. The amount of the second cleaning liquid is smaller than the volume of the container 430 at the upstream side of the nucleic acid collector. The outlet flow path 251 including the bent portion is connected to the radially outer side of the second cleaning liquid container 250. The outlet flow path 251 includes the enlarged flow path portion 258. As shown in FIG. 2, the air flow path 252, enlarged flow path portion 253 and air filter 256 are connected to the radially inner side of the second cleaning liquid container 250.

An explanation is give with making reference to FIGS. 24-26 the motor 11 is stopped, and the penetrator 13 penetrate the cartridge cover 199 on the upper side of the air filter 256. Thereby, the second cleaning liquid container 250 is connected to the atmosphere. The ethanol or aqueous solution of ethanol used as the second cleaning liquid has very high adhesion property. Therefore, when the centrifugal force is not applied, the liquid surface level of the second cleaning liquid moves through the outlet flow path 251 with capillary phenomenon to reach the boundary with respect to the enlarged flow path portion 258. However, the capillary force changes at the enlarged flow path portion 258 to prevent with a surface tension of the liquid the liquid surface level from being moved. Therefore, the liquid surface level of the second cleaning liquid reaches the boundary with respect to the enlarged flow path portion 258, but is stopped thereat.

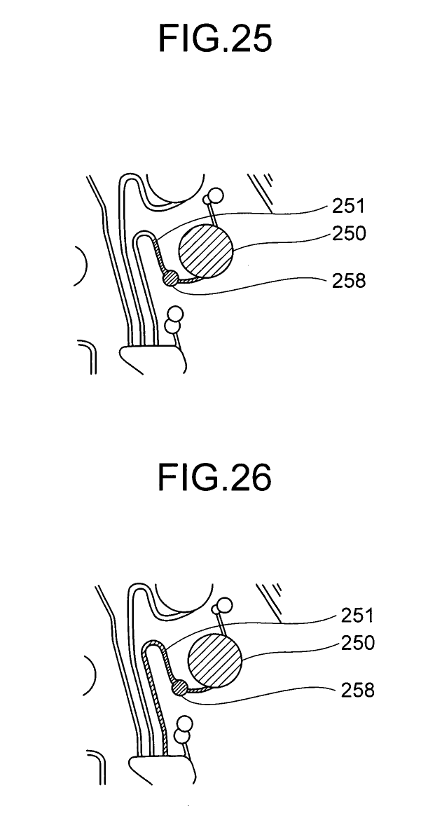

When the motor 11 is rotationally activated, the centrifugal force is generated so that, as shown in FIG. 25, the second cleaning liquid ascends over the enlarged flow path portion 258 in accordance with a difference in water head between the liquid surface level of the second cleaning liquid in the second cleaning liquid container 250 and the liquid surface level of the second cleaning liquid in the outlet flow path 251.

By stopping the motor 11 in this situation, the centrifugal force is not generated, and, as shown in FIG. 26, the second cleaning liquid moves from the outlet flow path 251 with the capillary phenomenon to reach the bent portion of the outlet flow path 251. By activating rotationally the motor 11 is rotationally activated again to generate the centrifugal force, the second cleaning liquid flows with siphon effect from the outlet flow path 251 into the container 430 at the upstream side of the nucleic acid collector.

The second cleaning liquid flows from the container 430 at the upstream side of the nucleic acid collector to the nucleic acid collector 700 to wash out the unrequired component such as salt or the like from the nucleic acid collecting filter 254. The waste liquid after the cleaning flows to the waste liquid container 900 through the enlarged flow path portion 822 and the eluate liquid collecting container 390.

In the embodiment, by the enlarged flow path portion 258 arranged on the outlet flow path 251, the outlet flow path 251 is prevented from excessively filled with the second cleaning liquid. For example, for introducing the second cleaning liquid into the second cleaning liquid container 250, the cartridge cover on the upper side of the second cleaning liquid container 250 is penetrated to form a hole, the second cleaning liquid is introduced, and subsequently the hole is closed, or the cartridge cover is mounted after the second cleaning liquid is introduced into the second cleaning liquid container 250. During this introduction step, after the second cleaning liquid is introduced into the second cleaning liquid container 250, there is a probability of that the outlet flow path 251 is filled with the second cleaning liquid with capillary phenomenon, and the second cleaning liquid flows out of the outlet flow path 251. However, by the enlarged flow path portion 258, the second cleaning liquid is prevented from further proceeding over it.

Further, the enlarged flow path portion 258 arranged on the outlet flow path 251 causes another effect. As described above, if the centrifugal force is generated before the penetration, the second cleaning liquid is urged from the second cleaning liquid container 250 toward the outlet flow path 251 so that a part of the second cleaning liquid flows into the outlet flow path 251. The air of small amount in the second cleaning liquid container 250 expands by a volume of the second cleaning liquid moved into the outlet flow path 251. The negative pressure caused by the air expansion holds the second cleaning liquid in the second cleaning liquid container 250 against the centrifugal force. When they balance each other, the liquid surface level is stable. However, when the pressing force by the centrifugal force is greater, there is a probability of that the second cleaning liquid proceeds over the bent portion of the outlet flow path 251 to flow out. In this embodiment, by the enlarged flow path portion, the volume of the second cleaning liquid flowing out of the second cleaning liquid container 250 with the centrifugal force is great. The expansion degree of the air of small amount in the second cleaning liquid container 250 increases in accordance thereto so that the negative pressure thereby increases. Therefore, before the penetration, the second cleaning liquid is securely held in the second cleaning liquid container 250.

Incidentally, similarly to the enlarged flow path portion arranged on the air filter, the enlarged flow path portion may be replaced by the region onto which the hydrophobic property is applied to obtain the same effect.

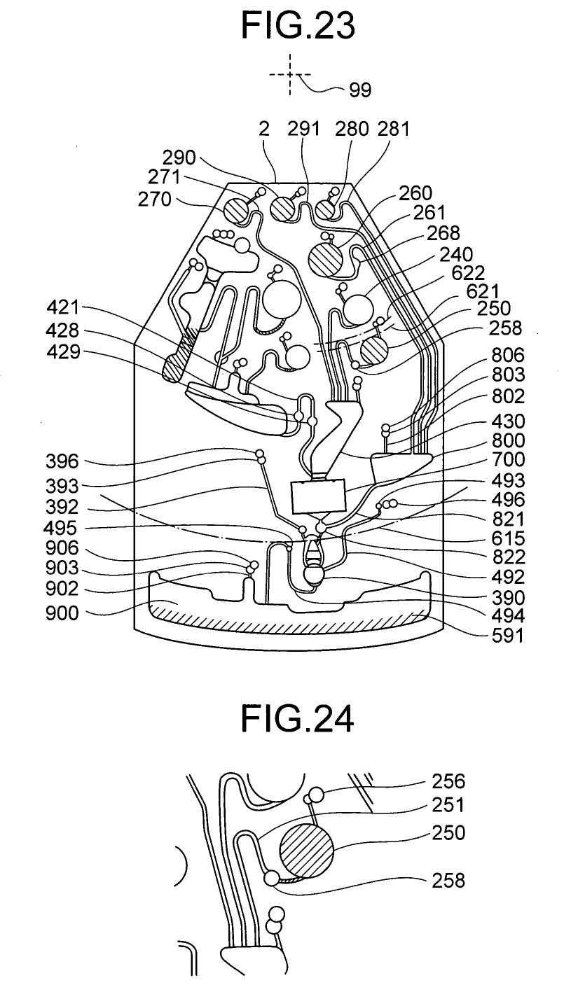

As shown in FIG. 23, the liquid surface level 621 of the second cleaning liquid in the second cleaning liquid container 250 is positioned at the radially outer side with respect to the radially innermost position 622 of the bent portion of the outlet path. Thereby, the second cleaning liquid is securely prevented from flowing out when the centrifugal force is applied before the penetration. In this embodiment, if the negative pressure caused by the expansion of the air of small amount in the second cleaning liquid container 250 is not sufficient, the second cleaning liquid urged by the centrifugal force cannot proceeds over the bent portion of the outlet flow path 251. Therefore, the second cleaning liquid does not flows out from the second cleaning liquid container 250 through the outlet flow path before the penetration.

Finally, with making reference again to FIG. 23, the third cleaning step is performed. The third cleaning liquid container 260 contains the third cleaning liquid for washing out a component of salt or the like from the eluate liquid collecting container 390. The third cleaning liquid may be a sterilized water or a water solution of adjusted pH of 7-9. The outlet flow path 261 including the bent portion is connected at the radially outer side of the third cleaning liquid container 260. The outlet flow path 261 has the enlarged flow path portion 268. The function of the enlarged flow path portion 268 is equal to the function of the enlarged flow path portion 258 of the outlet flow path 251 of the second cleaning liquid container 250 so that it is not explained. As shown in FIG. 2, the air flow path 262, enlarged flow path portion 263 and air filter 266 are connected to the radially inner side of the third cleaning liquid container 260.

The buffer container 800 has the buffer container air flow path 802, enlarged flow path portion 803 and air filter 806.

The motor 11 is stopped, and the penetrator 13 penetrates the cartridge cover 199 on the upper side of the air filters 266 and 806. Thereby, the buffer container 800 and the third cleaning liquid container 260 are connected to the atmosphere. By the centrifugal force caused by rotationally activating the motor 11, the third cleaning liquid flows from the third cleaning liquid container 260 through the third cleaning liquid container outlet flow path 261, buffer container 800, outlet flow path 821 and enlarged flow path portion 822 to the eluate liquid collecting container 390 so that the component of salt or the like is washed out from the eluate liquid collecting container 390. The waste liquid after the cleaning flows out to the waste liquid container 900.

The buffer container brings about the following effect. As described below, the first and second amplifying liquids after the third cleaning liquid flow into the eluate liquid collecting container 390, however, it is not preferable for three flow paths to be connected to the eluate liquid collecting container 390. A reason for this is that, as described below, the numerous flow paths deteriorate the detection or cannot restrain the liquid from vaporizing during the amplifying reaction. Therefore, after the flow paths for the third cleaning liquid and the first and second amplifying liquids are joined with each other, they may be connected to the eluate liquid collecting container 390. However, joining the flow paths for the third cleaning liquid and the first and second amplifying liquids with each other causes a probability of that the flow of one of the liquid generates the flow of the other one thereof at the jointing portion. For example, there is a probability of that the flow of the third cleaning liquid causes the flows of the first and second amplifying liquids at the joining portion. Similarly, there is a probability of that the flow of the first amplifying liquid causes the flow of the second amplifying liquid at the joining portion.

In this embodiment, the flow paths for the third cleaning liquid and the first and second amplifying liquids are joined with each other at the buffer container 800, while the buffer container is connected to the atmosphere through the air filter 806. Therefore, the flow of the third cleaning liquid does not cause the flows of the first and second amplifying liquids. The flow of the first amplifying liquid does not cause the flow of the second amplifying liquid. The eluting process for the nucleic acid is performed after the cleaning process.

The eluting process at step S500 is explained. The eluate liquid container 270 contains the eluate liquid for eluting the nucleic acid collected by the nucleic acid collecting filter 454 of the nucleic acid collector 700. The eluate liquid may be a water or an aqueous solution of adjusted pH of 7-9. The volume of the eluate liquid is smaller than the volume of the buffer container 800. The outlet flow path 271 including the bent portion is connected to the radially outer side of the eluate liquid container 270. As shown in FIG. 2, the air flow path 272, enlarged flow path portion 273 and air filter 276 are connected to the radially inner side of the eluate liquid container 270.

The motor is stopped, and the penetrator 13 penetrates the cartridge cover on the upper side of the air filter 276. Thereby, the eluate liquid container 270 is connected to the atmosphere. The centrifugal force generated by the rotationally activated motor 11 causes the flow of the eluate liquid from the eluate liquid container 270 into the nucleic acid collector 700 through the outlet flow path 271 and the container 430 at the upstream side of the nucleic acid collector. The collected by the nucleic acid collecting filter 454 in the nucleic acid collector 700 is eluted by the eluate liquid. The eluate liquid including the eluted nucleic acid flows from the nucleic acid collector 700 into the eluate liquid collecting container 390. Next, the first amplifying process is explained.

The amplifying process at step S600 is explained. The amplifying process includes the first and second amplifying steps. The first amplifying liquid container 290 contains the first amplifying liquid 297 for detecting the nucleic acid with amplification. The first amplifying liquid 297 may be a reagent including, for example, deoxynucleoside triphosphate, fluorescence agent and so forth. The volume of the first amplifying liquid 297 is smaller than the volume of the buffer container 800. The outlet flow path 291 including the bent portion is connected to the radially outer side of the first amplifying liquid container 290. As shown in FIG. 2, the air flow path 292, enlarged flow path portion 293 and air filter 296 are connected to the radially inner side of the first amplifying liquid container 290.

The motor 11 is stopped, and the penetrator 13 penetrates the cartridge cover on the upper side of the air filter 296. Thereby, the first amplifying liquid container 290 is connected to the atmosphere. The centrifugal force generated by rotationally activating the motor 11 causes the flow of the first amplifying liquid 297 from the first amplifying liquid container 290 through the outlet flow path 291 and buffer container 800 into the eluate liquid collecting container 390. In the eluate liquid collecting container 390, the nucleic acid is amplified by the first amplifying liquid 297.

After the whole of the first amplifying liquid 297 flows into the eluate liquid collecting container 390, the motor 11 is stopped, and the eluate liquid collecting container 390 is heated by the heater 14. The heater may be moved to the position over the eluate liquid collecting container 390, or alternatively the holding disk may be rotated so that the inspection cartridge is moved under the heater. The heater 14 keeps the temperature of the eluate liquid collecting container 390 appropriate.

Next, the second amplifying step is performed. The second amplifying liquid container 280 contains the second amplifying liquid 287 for detecting the nucleic acid with amplification. The second amplifying liquid 287 may be a reagent including enzyme for amplification. The volume of the second amplifying liquid 287 is smaller than the volume of the buffer container 800. The outlet flow path 281 including the bent portion is connected to the radially outer side of the second amplifying liquid container 280. As shown in FIG. 2, the air flow path 282, enlarged flow path portion 283 and air filter 285 are connected to the radially inner side of the second amplifying liquid container 280.

The penetrator 13 penetrates the cartridge cover 199 on the upper side of the air filter 286. Thereby, the second amplifying liquid container 280 is connected to the atmosphere. By the centrifugal force generated by rotationally activating the motor 11, the second amplifying liquid 287 flows from the second amplifying liquid container 280 into the eluate liquid collecting container 390 through the outlet flow path 281, buffer container 800, outlet flow path and enlarged flow path portion 822. The nucleic acid is amplified by the second amplifying liquid 287 in the eluate liquid collecting container 390.

After the whole of the second amplifying liquid 287 flows into the eluate liquid collecting container 390, the motor 11 is stopped, and the eluate liquid collecting container 390 is heated by the heater. Thereby the temperature of the eluate liquid collecting container 390 is kept appropriate.

The nucleic acid is amplified during a predetermined time period under temperature control. Finally, the inspection at step S700 is performed. That is, the detecting device 15 detects the nucleic acid amplified in the eluate liquid collecting container 390. The heated condition is kept during a time period necessary for the amplification and detection, for example, 30 minutes to two hours.

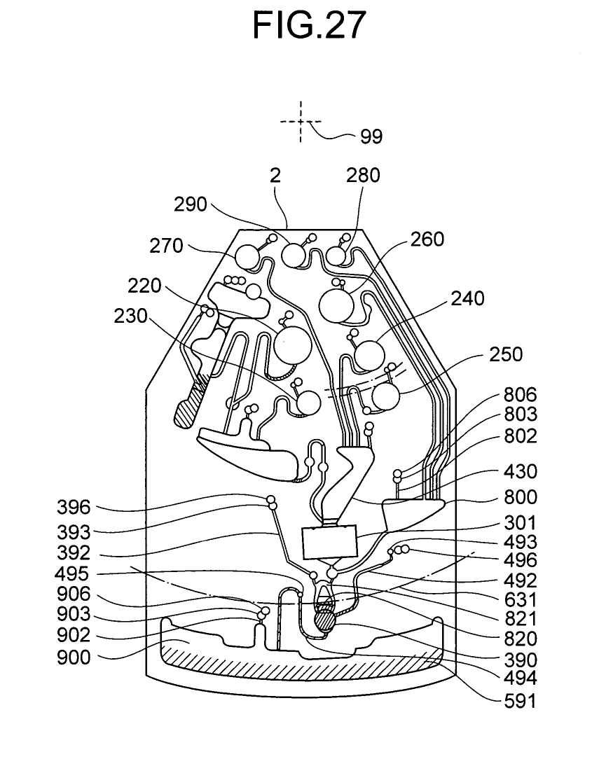

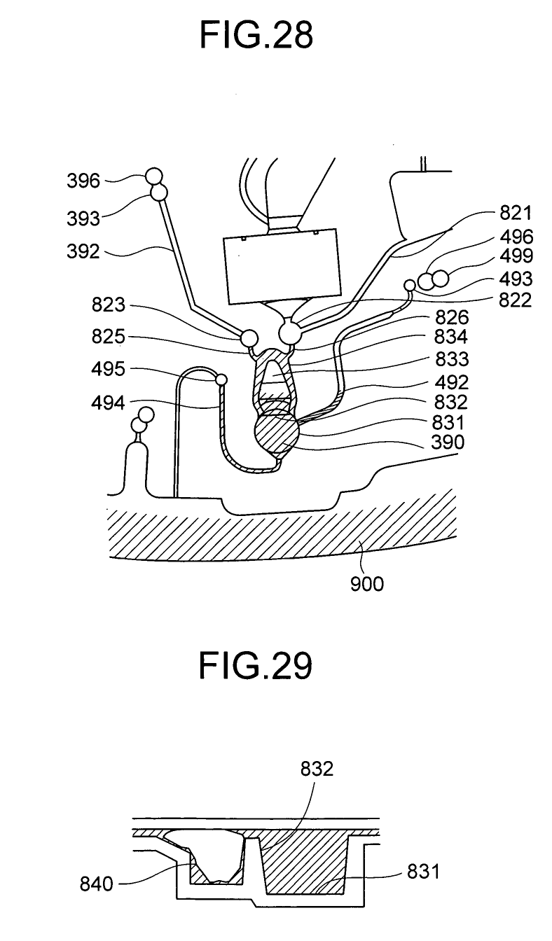

FIG. 27 shows the eluate liquid collecting container 390 into which the whole of the second amplifying liquid flows. Incidentally, in this situation, the motor 11 is rotating. FIG. 28 shows a situation in which the motor 11 is stopped after the whole of the second amplifying liquid flows into the eluate liquid collecting container 390. The eluate liquid collecting container 390 contains a liquid (amplified reaction liquid) as the mixture of the eluate liquid and the first and second amplifying liquids.

The structure of the eluate liquid collecting container 390 is explained. The eluate liquid collecting container 390 has the detecting portion as the circular recess at the radially outer side and a substantially triangle portion at the radially inner side, and a partition wall 832 as a dam is arranged therebetween. The triangle portion has a central triangular portion 833 and a small-depth groove 834 surrounding it. Therefore, the central triangular portion 833 projects from the surrounding groove 834.

The eluate liquid collecting container air flow path 825 is connected to the radially inner side of the triangular portion extending to the enlarged flow path portion 823.. The air flow path 392 is arranged between the enlarged flow path portion 823 and the enlarged flow path portion 393. The air filter 396 is arranged at the upstream side of the enlarged flow path portion. The eluate liquid collecting container eluate liquid flow path 826 is connected to the radially inner side of the triangular portion extending to the enlarged flow path portion 822. The enlarged flow path portion 822 is connected to the nucleic acid collector 700, and connected to the buffer container 800 through the outlet flow path 821.

The detecting portion 831 is connected to the buffer flow path 492 extending to the enlarged flow path portion 493 as described above. The enlarged flow path portion 493 is connected to the air filter 496 and a space for being penetrated. The outlet flow path 494 including the bent portion is connected to the radially outer side of the detecting portion 831, and the outlet flow path 494 includes the enlarged flow path portion 495.

As shown in FIG. 27, when the motor 11 is rotating after the whole of the second amplifying liquid flows into the eluate liquid collecting container 390, the liquid surface level in the eluate liquid collecting container 390 is slightly radially inner than the partition wall 832 and radially outer than the enlarged flow path portion 495 of the outlet flow path.

When the motor 11 is stopped as shown in FIG. 28, since the centrifugal force is not applied, the eluate moves radially inward with capillary phenomenon from the eluate liquid collecting container 390 to fill the small-depth groove 834 and further the eluate liquid collecting container air flow path 825 and eluate liquid collecting container eluate liquid flow path 826. However, since the eluate liquid collecting container air flow path 825 is connected to the enlarged flow path portion 823, the liquid surface level is restrained by the surface tension of the liquid from moving to stop at the boundary with respect to the enlarged flow path portion 823. Similarly, since the eluate liquid collecting container eluate liquid flow path 826 is connected to the enlarged flow path portion 822, the liquid surface level is restrained by the surface tension of the liquid from moving to stop at the boundary with respect to the enlarged flow path portion 822.

The eluate proceeds with capillary phenomenon from the eluate liquid collecting container 390 through the outlet path 494, however, the movement of the liquid surface is restrained by the surface tension of the liquid at the enlarged flow path portion 495 to stop at the boundary with respect to the enlarged flow path portion 495.

The cross sectional area of the buffer flow path is set in such a manner that the capillary force in the buffer flow path 492 is smaller than the capillary force in the eluate liquid collecting container air flow path 825 and eluate liquid collecting container eluate liquid flow path 826. Generally, the capillary force in the flow path is calculated along the following formula.
P=[2(h+w)/(hw)]γ cos θ

Herein, h is a height of the flow path, w is a width of the flow path, γ is a surface tension of the liquid, and θ is a contact angle of the liquid with respect to the wall surface of the flow path. In the buffer flow path 492 of the embodiment, a ratio between the width of the flow path and the depth thereof is substantially 1, and the width is wider than the eluate liquid collecting container outlet flow path 494, eluate liquid collecting container air flow path 825 and eluate liquid collecting container eluate liquid flow path 826. Therefore, the capillary force (pressure) for urging the liquid surface into the eluate liquid collecting container outlet flow path 494, eluate liquid collecting container air flow path 825 and eluate liquid collecting container eluate liquid flow path 826 is greater than the capillary force for urging the liquid surface into the buffer flow path 492. The liquid surface in the buffer flow path 492 moves in accordance with the movement of the liquid surface in the other flow path, and finally returns toward the eluate liquid collecting container 390. Therefore, in the eluate liquid collecting container outlet flow path 494, eluate liquid collecting container air flow path 825 and eluate liquid collecting container eluate liquid flow path 826, the liquid surface moves smoothly with capillary force so that they are filled with the amplified reaction liquid.

In a case without the buffer flow path 492, there is a probability of that the surfaces of the liquids cannot be moved smoothly by the capillary forces in the respective eluate liquid collecting container outlet flow path 494, eluate liquid collecting container air flow path 825 and eluate liquid collecting container eluate liquid flow path 826, because the liquid surfaces the liquids in them are drawn to each other against the capillary forces.

Further, by heating the eluate liquid collecting container 390 during the amplifying reaction process, the air stored therein expands. In this situation, the volume change is absorbed by the movement of the liquid surface in the buffer flow path 492 to prevent the liquid surface from moving in the other flow path.

Further, the capillary force in the eluate liquid collecting container outlet flow path 494 may be smaller than the capillary force of each of the eluate liquid collecting container air flow path 825 and eluate liquid collecting container eluate liquid flow path 826, instead of using the buffer flow path. In this case, the eluate liquid collecting container outlet flow path 494 brings about the function of the buffer flow path 492. That is, the liquid surface moves in the other flow path with returning of the liquid surface in the eluate liquid collecting container outlet flow path 494.

In this embodiment, the eluate liquid collecting container 390 can contain the whole amount of the eluate liquid, first amplifying liquid and second amplifying liquid (amplified reaction liquid), and the liquid surface level 631 of the eluate liquid collecting container 390 is, as shown in FIG. 27, when the motor 11 is rotating, at the radially inner side with respect to the partition wall 832 and the radially inner side with respect to the enlarged flow path portion 495 of the eluate liquid collecting container outlet flow path 494. Further, in response to the stoppage of the motor 11, the liquid surface level in the eluate liquid collecting container 390 moves, as shown in FIG. 28, into the small-depth groove 834 of the radially inner side. This structure brings about the following effect.

Since the eluate liquid collecting container outlet flow path 494 has the enlarged flow path portion 495, the liquid in the eluate liquid collecting container outlet flow path 494 is prevented from proceeding over the bent portion with the capillary phenomenon when the motor 11 is stopped. Therefore, when the motor 11 restarts to rotate, the liquid is prevented from flowing from the eluate liquid collecting container outlet flow path 494 into the waste liquid container 900. Therefore, the eluate, first and second liquids can be securely held in the eluate liquid collecting container 390. Further, when the cleaning liquid flows into the eluate liquid collecting container 390, since the volume of the cleaning liquid is greater than the volume of the eluate liquid collecting container 390, the liquid surface level of the cleaning liquid in the eluate liquid collecting container 390 is radially inside with respect to the enlarged flow path portion 495. Therefore, the movement of the cleaning liquid by the centrifugal force is not prevented from the enlarged flow path portion 495 so that the cleaning liquid reaches the waste liquid container 900.

Further, when the motor 11 is stopped, the liquid in the eluate liquid collecting container 390 moves to the radially inside thereof with the capillary phenomenon to move to the eluate liquid collecting container air flow path 825 and eluate liquid collecting container eluate liquid flow path 826 through the small-thickness groove 834. Therefore, the boundary surface between the liquid and the air is formed not in the eluate liquid collecting container 390, but is in the eluate liquid collecting container air flow path 825 and eluate liquid collecting container eluate liquid flow path 826. An area of the boundary surface between the liquid and the air may be decreased to the same as the cross sectional area of the flow path. That is, since an evaporable area of the liquid can be significantly decreased, the amount of the amplified reaction liquid is prevented from being decreased by being vaporized during the amplifying process.

If the boundary surface between the liquid and the air is formed in the eluate liquid collecting container 390, the evaporable area of the liquid is increased so that the amount of the amplified reaction liquid is decreased or becomes zero by being vaporized during the amplifying process. If the amount of the amplified reaction liquid is decreased, the detection cannot be performed correctly. For preventing this, a special operation such as closing the hole formed by the penetration or the like for preventing the vaporization is needed.

FIG. 29 shows a cross section of the eluate liquid collecting container 390. The air 840 exists at the radially inner side with respect to the partition wall 832 in the eluate liquid collecting container 390. However, the air 840 is prevented by the partition wall 832 from moving to the radially outer side. The detecting portion 831 is filled with the amplified reaction liquid, and does not includes gaseous bubble. Therefore, by performing the detection at the upper or lower surface side of the detecting portion 831 in the detecting device 15, the detection of the amplified reaction can be performed stably without being deteriorated by the existence or movement of the boundary surface between the liquid and the air.

The small-depth groove 834 of the eluate liquid collecting container 390 acts to move with the capillary phenomenon the liquid from the eluate liquid collecting container 390 to the eluate liquid collecting container air flow path 825 and eluate liquid collecting container eluate liquid flow path 826. Another structure for moving with the capillary phenomenon the liquid to the eluate liquid collecting container air flow path 825 and eluate liquid collecting container eluate liquid flow path 826 may be used. For example, another shape or material for increased capillary force may be used. The small-depth groove may be replaced by a great-depth groove receiving therein another member having micro-holes such as filter.

Further, the partition wall 832 of the eluate liquid collecting container 390 has a dam-like shape whose upper side is opened to form a gap between the cartridge cover and the partition wall as shown in FIG. 29. However, any shape for preventing the air 840 from moving to the detecting portion 831, for example, the partition wall having a thin groove extending in the depth direction, can be used.

Further, the air filters may be arranged only for the air flow paths 222, 232, 332, 422, 432, 392, 492 and 902 of the container through which the specimen flows, although the air filters are arranged for all of the positions to be penetrated in the embodiment of the inspection cartridge. In this case, there is a probability of that the mist of the specimen flows out from the penetrated position on which the air filter is not arranged. However, the most important specimen can be prevented from flowing out, and a number of the positions on which the air filter are mounted is decreased to make the production easy.

Further, a plurality of the air flow paths may be joined with each other to be connected to the air filter. Thereby, the number of the positions on which the air filter are mounted is decreased to make the production easy.

As described above, in a chemical analysis device as the embodiment of the invention having a holder disk rotatable on a central rotational axis, and an inspection cartridge detachably mounted on the holder disk, the inspection cartridge having a substrate including containers formed as recesses and flow paths and a cover covering the containers and flow paths so that a liquid is moved by a centrifugal force generated by a rotation of the holder disk from the container at a radially inner side with respect to the rotational axis to the container at a radially outer side with respect to the rotational axis, the substrate has air flow paths and filter portions connected to the containers through the air flow paths, and the container is capable of being connected to the atmosphere through the air flow path and filter portion after the cover is penetrated.

The air flow path has a portion for decreasing a capillary force. The portion for decreasing the capillary force is an enlarged flow path portion having an enlarged cross sectional area of the flow path decreasing the capillary force sufficiently for preventing the liquid urged (only) by the capillary force from passing through the enlarged flow path portion. The portion for decreasing the capillary force is an region of the flow path to which a hydrophobic property decreasing the capillary force sufficiently for preventing the liquid urged (only) by the capillary force from passing through the enlarged flow path portion is applied. The air flow paths extend radially inward from radially inner side ends of the containers.

In a chemical analysis device as the embodiment of the invention having a holder disk rotatable on a central rotational axis, and an inspection cartridge detachably mounted on the holder disk, the inspection cartridge having a substrate including containers formed as recesses and flow paths and a cover covering the containers and flow paths so that a liquid is moved by a centrifugal force generated by a rotation of the holder disk from the container at a radially inner side with respect to the rotational axis to the container at a radially outer side with respect to the rotational axis, the flow path for moving the liquid from the container at the radially inner side to the container at the radially outer side extends though a bent portion thereof extending radially inward from a radially outer side end of the container at the radially inner side and subsequently extending radially outward toward the container at the radially outer side.

The containers formed on the inspection cartridge has a specimen container for containing a specimen and a specimen holder container connected to the specimen container and including a first part and a second part at a radially outer side with respect to the first part so that a part of small specific gravity of the specimen urged by the centrifugal force is contained by the first part and another part of great specific gravity of the specimen urged thereby is contained by the second part.

The containers formed on the inspection cartridge has a specimen holder container for containing the specimen, a reagent container for containing a reagent and a reaction container in which the specimen and reagent react each other, a specimen holder container outlet flow path connecting the specimen holder container and reaction container to each other extends to a radially inner side end of the reaction container through a bent portion thereof extending radially inward from the specimen holder container and subsequently extending radially outward, a reagent container outlet flow path connecting the reagent container and reaction container to each other extends to the reaction container through a bent portion thereof extending radially inward from the reaction container and subsequently extending radially outward, and the specimen holder container outlet flow path and the reagent container outlet flow path are connected to each other to converge with each other at a joint position between the bent portions and the reaction container so that the specimen in the specimen holder container outlet flow path is withdrawn to generate its flow from the specimen holder container to the reaction container by the flow of the reagent from the reagent container to the reaction container generated by the centrifugal force, while a liquid surface level of the specimen in the specimen holder container is positioned at a radially outer side with respect to the radially innermost position or peak (of a radially outer side wall of specimen flow path as seen in a direction parallel to the rotational axis) of the bent portion of the specimen holder container outlet path, that is, a peak of dam for preventing a flow urged radially outward by the centrifugal force in the specimen holder container outlet path from proceeding circumferentially over the dam to proceed radially inward and subsequently radially outward over the dam when the specimen and reagent are moved by the centrifugal force from the specimen holder container and the reagent container to the reaction container.

A flow rate of the specimen from the specimen holder container outlet flow path to the reaction container is smaller than a flow rate of the reagent from the reagent container outlet flow path to the reaction container.

A flow resistance of the specimen holder container outlet flow path is greater than a flow resistance of the reagent container outlet flow path. A cross sectional area of the specimen holder container outlet flow path is smaller than a cross sectional area of the reagent container outlet flow path. A radially outermost position of the bent portion of the specimen holder container outlet flow path is at a radially inner side with respect to a radially outermost position of the bent portion of the reagent container outlet flow path. A radial distance between the joint position and an inlet of the reaction container is longer than a radial distance between a radially outermost position of the reaction container and the joint position. A cross sectional area of the flow path between the joint position and the inlet of the reaction container is not more than greater one of a cross sectional area of the specimen holder container outlet flow path and a cross sectional area of the reagent container outlet flow path. An angle formed between the flow path from the joint position and the inlet of the reaction container (at the joint position) and the specimen holder container outlet flow path (at the joint position) is greater than an angle formed between the flow path from the joint position and the inlet of the reaction container (at the joint position) and the reaction container outlet flow path (at the joint position).

In a chemical analysis device as the embodiment of the invention having a holder disk rotatable on a central rotational axis, and an inspection cartridge detachably mounted on the holder disk, the inspection cartridge having a substrate including containers formed as recesses and flow paths and a cover covering the containers and flow paths so that a liquid is moved by a centrifugal force generated by a rotation of the holder disk from the container at a radially inner side with respect to the rotational axis to the container at a radially outer side with respect to the rotational axis, the flow path for moving the liquid from the container at the radially inner side to the container at the radially outer side extends though a bent portion thereof extending radially inward from a radially outer side end of the container at the radially inner side and subsequently extending radially outward toward the container at the radially outer side, a nucleic acid collector for collecting a nucleic acid from the specimen is mounted on the substrate, the nucleic acid collector has a filter holder to be incorporated into the substrate as a separate member with respect to the substrate, and the filter holder includes a nucleic acid collecting filter for collecting the nucleic acid from the specimen.

The filter holder is mounded on one of sides of the substrate on which the cover is mounted, and an outer surface of the filter holder and a surface of the one of sides of the substrate form a common plane. The filter holder has a wall portion whose thickness is shorter than the whole length of the filter holder, and the wall portion is arranged at an upstream side with respect to the nucleic acid collecting filter in a liquid flowing direction. The filter holder is mounted on the other one of the sides of the substrate opposite to the one of the sides of the substrate on which the cover is mounted. The filter holder has a liquid storing portion at an upstream side with respect to the nucleic acid collecting filter in the liquid flowing direction, a volume of which liquid storing portion is greater than a maximum amount of the liquid passing through the nucleic acid collecting filter per each operation. The inspection cartridge has a container at the upstream side of the nucleic acid collector, a radially innermost position of which container is at a radially inner side with respect to a radially outermost position of the reaction container.

In a chemical analysis device as the embodiment of the invention having a holder disk rotatable on a central rotational axis, and an inspection cartridge detachably mounted on the holder disk, the inspection cartridge having a substrate including containers formed as recesses and flow paths and a cover covering the containers and flow paths so that a liquid is moved by a centrifugal force generated by a rotation of the holder disk from the container at a radially inner side with respect to the rotational axis to the container at a radially outer side with respect to the rotational axis, the flow path for moving the liquid from the container at the radially inner side to the container at the radially outer side extends though a bent portion thereof extending radially inward from a radially outer side end of the container at the radially inner side and subsequently extending radially outward toward the container at the radially outer side, the substrate has a specimen holder container for containing the specimen, a reagent container for containing a reagent, a reaction container for reacting the specimen and reagent with each other, a nucleic acid collector for collecting the nucleic acid from the specimen, a detection container having a detecting region for receiving a liquid including the nucleic acid from the nucleic acid collector, and a collecting container for receiving the liquid discharged from the detection container.

The substrate includes an eluate liquid container for containing an eluate liquid for eluting the nucleic acid collected by the nucleic acid collector and an eluate liquid container outlet flow path connecting the eluate liquid container and the nucleic acid collector to each other so that the eluate liquid urged by the centrifugal force moves from the eluate liquid container to the nucleic acid collector through the eluate liquid container outlet flow path to introduce the nucleic acid eluted by the eluate liquid to the detection container.

The substrate has a reagent container outlet flow path connected to the reagent container and a buffer container for introducing the reagent from the reagent container outlet flow path to the detection container so that the reagent urged by the centrifugal force moves from the reagent container through the reagent container outlet flow path to the buffer container to introduce the agent to the detection container.

The detection container has a first portion at a radially inner side and a second portion at a radially outer side, a partition wall as an ingate is arranged between the first and second portions so that gaseous bubble is prevented by the ingate from moving from the first portion to the second portion.

The substrate has a buffer flow path connected to the second portion of the detection container so that the cover is penetrated over the buffer flow path to connect the second portion to the atmosphere.

The first portion has a capillary force increasing region in which a capillary force is great, and the capillary force increasing region is connected to at least one of an air flow path connected to the first portion of the detection container to discharge the air and a confluent flow path for guiding the reagent or the liquid passing through the nucleic acid collector so that a liquid surface in the first portion of the detection container is positioned at a boundary between the air flow path connected to the detection container and the first portion and a boundary between the confluent flow path and the first portion.

The capillary force increasing region has a depth smaller than a depth of the second portion of the detecting container.

The air flow path connected to the first portion of the detection container or the confluent flow path has a capillary force decreasing region. The capillary force decreasing region is an enlarged flow path region. The capillary force decreasing region is a region to which a hydrophobic property is applied.

The air flow path connected to the first portion of the detection container and the confluent flow path extends radially inward from a radially inner side end of the first portion of the detection container.

The above mentioned flow path extends through a bent portion extending radially inward from a radially outer side end of the detection container and subsequently extending radially outward to a radially inner side end of the collecting container so that the liquid moves from the detection container at the radially inner side to the collecting container at the radially outer side, and the capillary force decreasing region is arranged between the radially outer side end of the detection container and the bent portion.

The capillary force decreasing region is an enlarged flow path portion with enlarged cross sectional area. The capillary force decreasing region is a region to which a hydrophobic property is applied.

Further, the device includes a heater for heating the liquid in the detection container and a detector for detecting a predetermined substance in the liquid in the detection container.

In a chemical analysis cartridge of the invention having a substrate including a flow path and containers formed as recesses, and a cover covering the flow path and container so that by a centrifugal force generated by a rotation of the substrate on a vertical rotational axis, the liquid moves from the container at a radially inner side with respect to the rotational axis through the flow path to the container at a radially outer side respect to the rotational axis,

the substrate has an air flow path so that the container is connected to the atmosphere through the air flow path after the cover is penetrated over the air flow path.

The flow path extending from the container at the radially inner side to the container at the radially outer side includes a bent portion extending radially inward from a radially outer side end of the container at the radially inner side and subsequently extending radially outward to a radially inner side end of the container at the radially outer side.

The substrate has a specimen holder container for containing a specimen, a reagent container for containing a reagent, a reaction container for reacting the specimen and reagent with each other, a nucleic acid collector for collecting the nucleic acid from the specimen, an eluate liquid container for containing an eluate liquid for eluting the nucleic acid collected by the nucleic acid collector, a detection container including a detection region for receiving the eluate including the nucleic acid from the nucleic acid collector, a buffer container for supplying a cleaning liquid to the detection container and a collecting container for collecting the liquid discharged from the detection container.

The nucleic acid collector has an engaging portion formed on the substrate and a filter holder to be incorporated into the engaging portion as a separate member with respect to the substrate, and the filter holder includes a nucleic acid collecting filter for collecting the nucleic acid from the specimen.

A filter portion is connected to the container through the air flow path so that the container is connected to the atmosphere through the filter portion and the air flow path by penetrating the cover. A part of the bent portion extending radially inward has an enlarged flow path portion with an enlarged cross sectional area.

The part of the bent portion extending radially inward has a capillary force decreasing portion. The capillary force decreasing portion is a region of the flow path to which hydrophobic property is applied.

The embodiments of the invention is described above, but it should be understood that the invention should not be restricted to the above mentioned embodiments and can be modified variously in the scope defined by claims.

It should be further understood by those skilled in the art that although the foregoing description has been made on embodiments of the invention, the invention is not limited thereto and various changes and modifications may be made without departing from the spirit of the invention and the scope of the appended claims.

1. A chemical analysis device comprising, a holder disk rotatable on a central rotational axis, and an inspection cartridge detachably mounted on the holder disk, the inspection cartridge having a substrate including containers formed as recesses and a flow path, and a cover covering the containers and flow path so that a liquid is moved by a centrifugal force generated by a rotation of the holder disk from the container at a radially inner side with respect to the rotational axis through the flow path to the container at a radially outer side with respect to the rotational axis,
wherein the substrate has an air flow path and a filter portion connected to the container through the air flow path, and the container is capable of being connected to the atmosphere through the air flow path and filter portion after the cover is penetrated.

2. A chemical analysis device comprising a holder disk rotatable on a central rotational axis, and an inspection cartridge detachably mounted on the holder disk, the inspection cartridge having a substrate including containers formed as recesses and a flow path, and a cover covering the containers and flow path so that a liquid is moved by a centrifugal force generated by a rotation of the holder disk from the container at a radially inner side with respect to the rotational axis to the container at a radially outer side with respect to the rotational axis, wherein the flow path for moving the liquid from the container at the radially inner side to the container at the radially outer side includes a bent portion extending radially inward from a radially outer side end of the container at the radially inner side and subsequently extending radially outward toward the container at the radially outer side.

3. A chemical analysis device according to claim 2, wherein the containers formed on the inspection cartridge includes a specimen container for containing a specimen and a specimen holder container connected to the specimen container and including a first part and a second part at a radially outer side with respect to the first part so that a part of small specific gravity of the specimen urged by the centrifugal force is contained by the first part and another part of great specific gravity of the specimen urged thereby is contained by the second part.

4. A chemical analysis device comprising a holder disk rotatable on a central rotational axis, and an inspection cartridge detachably mounted on the holder disk, the inspection cartridge having a substrate including containers formed as recesses and a flow path, and a cover covering the containers and flow path so that a liquid is moved by a centrifugal force generated by a rotation of the holder disk from the container at a radially inner side with respect to the rotational axis to the container at a radially outer side with respect to the rotational axis, wherein the containers formed on the inspection cartridge has a specimen holder container for containing the specimen, a reagent container for containing a reagent and a reaction container for reacting the specimen and reagent with each other, a specimen holder container outlet flow path connecting the specimen holder container and reaction container to each other includes a bent portion extending radially inward from the specimen holder container and subsequently extending radially outward to a radially inner side end of the reaction container, a reagent container outlet flow path connecting the reagent container and reaction container to each other, and
the specimen holder container outlet flow path and the reagent container outlet flow path are connected to each other to converge with each other at a joint position between the bent portion of the specimen holder container outlet flow path and the reaction container so that the specimen in the specimen holder container outlet flow path is withdrawn to generate its flow from the specimen holder container to the reaction container by the flow of the reagent from the reagent container to the reaction container generated by the centrifugal force,
while a liquid surface level of the specimen in the specimen holder container is positioned at a radially outer side with respect to the radially innermost position of the bent portion of the specimen holder container outlet flow path when the specimen and reagent are moved by the centrifugal force from the specimen holder container and the reagent container to the reaction container.

5. A chemical analysis device comprising a holder disk rotatable on a central rotational axis, and an inspection cartridge detachably mounted on the holder disk, the inspection cartridge having a substrate including containers formed as recesses and a flow path, and a cover covering the containers and flow path so that a liquid is moved by a centrifugal force generated by a rotation of the holder disk from the container at a radially inner side with respect to the rotational axis to the container at a radially outer side with respect to the rotational axis,
wherein a nucleic acid collector for collecting a nucleic acid from the specimen is mounted on the substrate, the nucleic acid collector has a filter holder to be incorporated into the substrate as a separate member with respect to the substrate, and the filter holder includes a nucleic acid collecting filter for collecting the nucleic acid from the specimen.

6. A chemical analysis device according to claim 5, wherein the filter holder has a wall portion whose thickness is shorter than the whole length of the filter holder, and the wall portion is arranged at an upstream side with respect to the nucleic acid collecting filter in a liquid flowing direction.

7. A chemical analysis device comprising a holder disk rotatable on a central rotational axis, and an inspection cartridge detachably mounted on the holder disk, the inspection cartridge having a substrate including containers formed as recesses and flow path, and a cover covering the containers and flow path so that a liquid is moved by a centrifugal force generated by a rotation of the holder disk from the container at a radially inner side with respect to the rotational axis to the container at a radially outer side with respect to the rotational axis,
wherein the substrate has a specimen holder container for containing the specimen, a reagent container for containing a reagent, a reaction container for reacting the specimen and reagent with each other, a nucleic acid collector for collecting the nucleic acid from the specimen, a detection container having a detecting region for receiving a liquid including the nucleic acid from the nucleic acid collector, and a collecting container for receiving the liquid discharged from the detection container.

8. A chemical analysis device according to claim 7, wherein the detection container has a first portion at a radially inner side and a second portion at a radially outer side, and a partition wall as a dam is arranged between the first and second portions so that gaseous bubble is prevented by the dam from moving from the first portion to the second portion.

9. A chemical analysis device according to claim 8, wherein the substrate has a buffer flow path connected to the second portion of the detection container so that the second portion is connected to the atmosphere by penetrating the cover over the buffer flow path.

10. A chemical analysis cartridge comprising a substrate including a flow path and containers formed as recesses, and a cover covering the flow path and container so that by a centrifugal force generated by a rotation of the substrate on a vertical rotational axis, the liquid is moved from the container at a radially inner side with respect to the rotational axis through the flow path to the container at a radially outer side respect to the rotational axis,
wherein the substrate has an air flow path so that the container is connected to the atmosphere through the air flow path by penetrating the cover over the air flow path.

11. A chemical analysis cartridge according to claim 10, wherein the substrate has a specimen holder container for containing a specimen, a reagent container for containing a reagent, a reaction container for reacting the specimen and reagent with each other, a nucleic acid collector for collecting the nucleic acid from the specimen, an eluate liquid container for containing an eluate liquid for eluting the nucleic acid collected by the nucleic acid collector, a detection container including a detection region for receiving the eluate including the nucleic acid from the nucleic acid collector, a buffer container for supplying a cleaning liquid to the detection container and a collecting container for collecting the liquid discharged from the detection container.
